(19) United States
(12) Patent Application Publication
(10) Pub. No.: US 2010/0309512 A1
(43) Pub. Date: Dec. 9, 2010

(54) DISPLAY CONTROL APPARATUS AND INFORMATION PROCESSING SYSTEM

(76) Inventor: Atsushi ONODA, Kanagawa (JP)

Correspondence Address: OBLON, SPIVAK, MCCLELLAND MAIER & NEUSTADT, L.L.P., 1940 DUKE STREET, ALEXANDRIA, VA, 22314, US

(21) Appl. No.: 12/778,403

(22) Filed: May 12, 2010

(30) Foreign Application Priority Data
Jun. 9, 2009 (JP) 2009-138075
Jan. 7, 2010 (JP) 2010-002328

(51) Int. Cl. G06F 3/12; G09G 5/08

(52) U.S. Cl. 358/1.15; 345/157

(57) ABSTRACT

A display control apparatus includes a display control unit configured to cause a display device to display a setting screen page to which a setting information item of a predetermined process is input, and to hide the setting screen page in response to an indication position of a pointing device moving out of a display region of the setting screen page.

### BACKGROUND OF THE INVENTION

1. Field of the Invention

The present invention relates to display control apparatuses and information processing systems.

2. Description of the Related Art

Typically, setting information for programs can be input via a screen (hereinafter, “setting screen page”) (see, for example, FIG. 5 of Japanese Laid-Open Patent Application No. 2009-294889). The user can easily change the behavior of a program by inputting setting information via the setting screen page. For example, by using a setting screen page for a printer driver, the printing format can be easily changed for document data.

The more setting items in a setting screen page, the more discretion the user has; however, the operation of setting the items on the screen page becomes more complex. One approach is to use appropriate display elements to set items on the setting screen page, for the purpose of improving operability. Examples of display elements are list boxes and check buttons.

In the conventional technology, room for improvement remains in terms of the operability of the various images (screen page, icons, etc.) including the setting screen page, which are used for controlling the programs.

### SUMMARY OF THE INVENTION

The present invention provides a display control apparatus and an information processing system, in which one or more of the above-described disadvantages are eliminated.

A preferred embodiment of the present invention provides a display control apparatus and an information processing system with which the operability of images relevant to programs can be improved.

According to an aspect of the present invention, there is provided a display control apparatus including a display control unit configured to cause a display device to display a setting screen page to which a setting information item of a predetermined process is input, and to hide the setting screen page in response to an indication position of a pointing device moving out of a display region of the setting screen page.

According to an aspect of the present invention, there is provided a display control apparatus including a display control unit configured to cause a display device to display a second image used for moving a first image expressing a predetermined program, the display device being caused to display the second image in response to an indication position of a pointing device moving into a display region of the first image; and a movement control unit configured to move a display position of the first image in response to the pointing device executing an operation on the second image.

According to an aspect of the present invention, there is provided an information processing system including an image forming apparatus and a program product, wherein the program product causes a computer connected to the image forming apparatus to execute a display control step of causing a display device to display a setting screen page to which a setting information item of a predetermined process is input, and to hide the setting screen page in response to an indication position of a pointing device moving out of a display region of the setting screen page; and a process request step of sending, to the image forming apparatus, a request to perform a process relevant to the predetermined process, in accordance with the setting information item.

According to one embodiment of the present invention, a display control apparatus and an information processing system are provided, with which the operability of images relevant to programs can be improved.

### BRIEF DESCRIPTION OF THE DRAWINGS

Other objects, features and advantages of the present invention will become more apparent from the following detailed description when read in conjunction with the accompanying drawings, in which:

FIG. 1 illustrates an information processing system according to an embodiment of the present invention;

FIG. 2 illustrates a hardware configuration of an image forming apparatus according to an embodiment of the present invention;

FIG. 3 illustrates a hardware configuration of a user terminal according to an embodiment of the present invention;

FIG. 4 illustrates functional configurations of a widget, a widget manager, and a provider application;

FIG. 5 illustrates a functional configuration of a widget UI unit of a print widget;

FIG. 6 illustrates examples of icons displayed on a display screen page according to a first embodiment of the present invention;

FIG. 7 is a sequence diagram for describing a process performed when the widget manager is activated;

FIG. 8 illustrates an example of a user management table;

FIG. 9 is a flowchart of a process performed when a job has been entered into the print widget;

FIG. 10 illustrates a displayed setting window of the print widget;

FIG. 11 illustrates a setting window that is gradually being erased;

FIG. 12 illustrates an example of the displayed print widget when setting information has been decided;

FIG. 13 is a sequence diagram for describing a process of the print widget after the setting information has been decided;

FIG. 14 illustrates an example of widget information of the print widget;

FIG. 15 is a sequence diagram for describing a process of displaying a list of widgets that can be executed;

FIG. 16 illustrates a displayed user selection screen page;

FIG. 17 illustrates a configuration of widget information of the print widget that is sent from the widget manager to the provider application;

FIG. 18 illustrates a displayed widget selection screen page;

FIG. 19 is a sequence diagram for describing a process of executing the print widget;

FIG. 20 illustrates a functional configuration of the widget UI unit of a scan widget;

FIG. 21 is a sequence diagram for describing a process performed when the scan widget is activated;

FIG. 22 illustrates a displayed scan widget;

FIG. 23 illustrates an example of widget information of the scan widget;

FIG. 24 illustrates a displayed setting window of the scan widget;

FIG. 25 is a sequence diagram for describing a process performed when executing the scan widget;

FIG. 26 illustrates a displayed job list window;

FIG. 27 is a flowchart of a process performed in accordance with operations in a job list window;

FIG. 28 illustrates a displayed setting window for scan image data;

FIG. 29 illustrates a displayed setting value selection menu;

FIG. 30 illustrates a displayed setting window after the setting value has been changed;

FIG. 31 illustrates an example where the setting window is gradually erased;

FIG. 32 illustrates a state where a blank region of the job list window is held;

FIG. 33 is a flowchart for describing the process of moving the scan widget by a simple operation;

FIG. 34 illustrates a displayed move-use icon for the scan widget;

FIG. 35 is a perspective view of the image forming apparatus, the user terminal, and the display device of the user terminal according to an embodiment of the present invention;

FIG. 36 is a reference diagram illustrating an example of an operation screen page of an operations panel of the image forming apparatus according to an embodiment of the present invention;

FIG. 37 is an enlarged view of a liquid display unit of the operations panel;

FIG. 38 is an enlarged view of a display screen page of a display device connected to the user terminal according to an embodiment of the present invention; and

FIGS. 39A through 39G are enlarged views of each of the widgets illustrated in FIGS. 37 and 38.

### DETAILED DESCRIPTION OF THE PREFERRED EMBODIMENTS

A description is given, with reference to the accompanying drawings, of embodiments of the present invention.

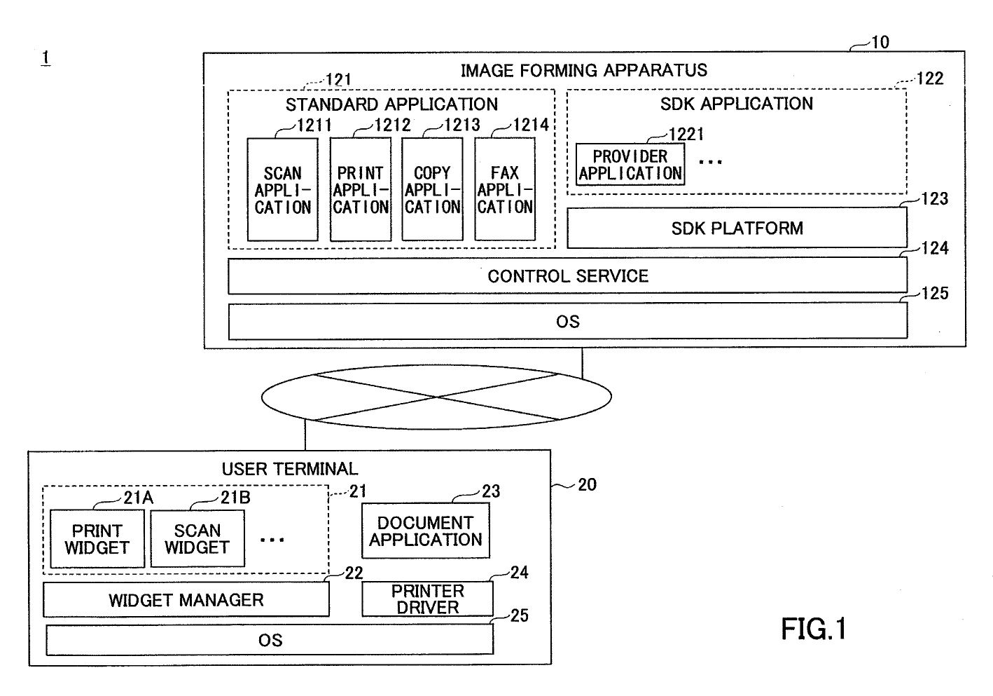

FIG. 1 illustrates an information processing system according to an embodiment of the present invention. An information processing system 1 shown in FIG. 1 includes at least one image forming apparatus 10 and at least one user terminal 20 which are connected via a network (wired or wireless) such as a LAN (Local Area Network) or the Internet.

The image forming apparatus 10 is a multifunction peripheral that implements plural functions in a single body. Examples of the functions are a scan function, a print function, a copy function, and a fax transmission/reception function. In the present embodiment, the image forming apparatus 10 preferably includes both a scan function and a print function. However, the image forming apparatus 10 may only include either one of a scan function or a print function.

The user terminal 20 may be a personal terminal used by the user, in which software programs can be installed and executed. The user terminal 20 may be any device as long as it has a communications function. Specific examples of the user terminal 20 are a desktop PC (Personal Computer), a notebook PC, a PDA (Personal Digital Assistance), and a mobile phone. In the present embodiment, the user terminal 20 functions as a display control apparatus.

A description is given of the software configuration of the user terminal 20. As shown in FIG. 1, the user terminal 20 includes a print widget 21A, a scan widget 21B, a widget manager 22, a document application 23, a printer driver 24, and an OS (Operating System) 25.

The print widget 21A and the scan widget 21B are application programs that may be collectively referred to as the “widget 21” in the present embodiment. In recent years and continuing, simple and convenient applications referred to as widgets and gadgets are available. In the present embodiment, applications that can be simply and conveniently installed and used are referred to as the widget 21 (i.e., the widget 21 does not limit the technical scope). In the present embodiment, the respective widgets 21 have a common feature of implementing predetermined process flows (for example, a workflow) with the use of the respective functions of the image forming apparatus 10.

The print widget 21A causes the image forming apparatus 10 to execute a print job based on print data generated for a predetermined logical printer.

The scan widget 21B causes the image forming apparatus 10 to execute a scanning process, and saves, in the user terminal 20, the image data obtained by the scanning process. The widget manager 22 mediates communications between the widget 21 and the image forming apparatus 10. The widget 21 preferably includes an interface and a processing procedure specified by the widget manager 22. That is to say, the widget 21 according to the present embodiment is the application that operates in collaboration with the widget manager 22.

The document application 23 is, for example, word processing software or spreadsheet software for creating electronic document data that may be a printing target. In FIG. 1, the document application 23 appears to be a single block, but plural document applications 23 may be provided according to the data formats of the document data.

The printer driver 24 is for generating print data relevant to document data generated by various document applications 23. When a logical printer corresponding to the print widget 21A is specified as the print destination, the printer driver 24 generates an intermediate file having a predetermined file name specified as the output destination for the logical printer, and outputs the print data to the intermediate file.

The OS 25 is a typical OS (Operating System), on which the software items of the user terminal 20 operate as a process or a thread.

A description is given of a software configuration of the image forming apparatus 10. As shown in FIG. 1, the image forming apparatus 10 includes a standard application 121, an SDK application 122, an SDK platform 123, a control service 124, and an OS 125.

The standard application 121 is an assembly of standard applications that are pre-installed in the image forming apparatus 10 at the time of shipment. Examples of the standard applications shown in FIG. 1 are a scan application 1211, a print application 1212, a copy application 1213, and a fax application 1214. The scan application 1211 executes scan jobs. The print application 1212 executes print jobs. The copy application 1213 executes copy jobs. The fax application 1214 executes fax transmission jobs and fax reception jobs.

The control service 124 is a group of software modules that provide functions for controlling various hardware resources, to upper level applications. Examples of such functions are a function relevant to network communications, a function for controlling the scanner, a function for controlling the printer, and a function for managing a memory.

The SDK application 122 is additionally installed after shipment of the image forming apparatus 10, as a plug-in for expanding the functions of the image forming apparatus 10. In FIG. 1, a provider application 1221 is shown as an example of the SDK application 122. The provider application 1221 executes a process so that the widget 21 can be operated from the image forming apparatus 10.

The SDK platform 123 provides an execution environment for the SDK application 122. The SDK application 122 is developed with the use of the API (Application Program Interface) provided by the SDK platform 123. The SDK platform 123 provides the SDK application 122 with an interface for using a scan function, an interface for using a print function, and an interface for using a copy function. The API of the SDK platform 123 is available to the public, and a third vendor can develop the SDK application 122.

The OS 125 is a typical OS (Operating System), on which various software items of the image forming apparatus 10 operate as a process or a thread.

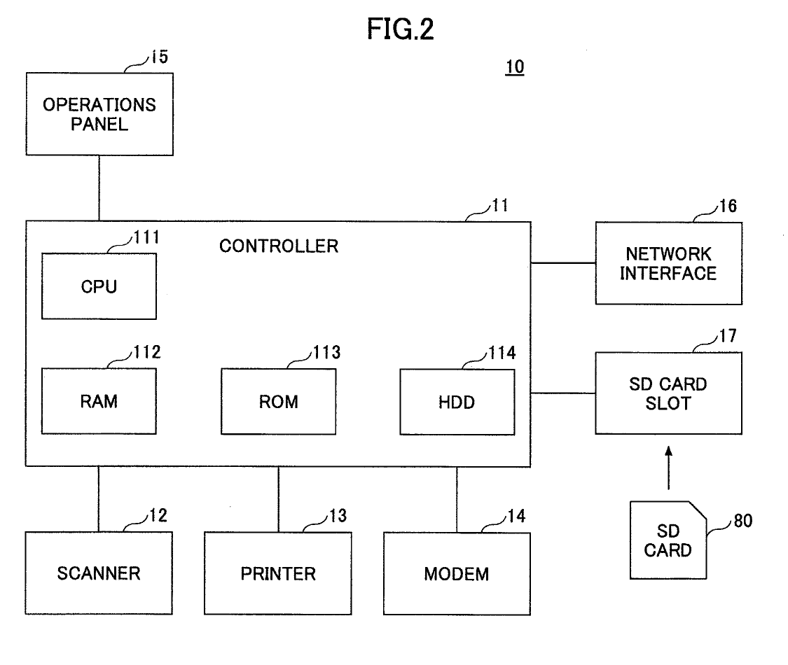

Next, a description is given of the hardware configurations of the respective devices. FIG. 2 illustrates a hardware configuration of the image forming apparatus 10 according to an embodiment of the present invention. As shown in FIG. 2, the image forming apparatus 10 includes hardware components such as a controller 11, a scanner 12, a printer 13, a modem 14, an operations panel 15, a network interface 16, and an SD card slot 17.

The controller 11 includes a CPU 111, a RAM 112, a ROM 113, and a HDD 114. The ROM 113 records various programs and data used by the programs. The RAM 112 is used as a storage region for loading programs and a work region for the loaded programs. The CPU 111 processes the programs loaded in the RAM 112 to implement various functions. The HDD 114 stores programs and various data items used by the programs.

The scanner 12 is a hardware component for scanning an original to obtain image data. The printer 13 is a hardware component for printing the print data onto a sheet. The modem 14 is a hardware component for connecting the image forming apparatus 10 to a telephone line, and is used for transmitting/receiving image data by fax communication. The operations panel 15 is a hardware component including an input unit such as buttons to receive input from a user, and a display unit such as a liquid crystal display unit. The network interface 16 is a hardware component for connecting the image forming apparatus 10 to a network (wired or wireless) such as a LAN. The SD card slot 17 is used for reading a program recorded in an SD card 80. That is to say, in the image forming apparatus 10, the programs recorded in the ROM 113 may be executed, and the programs recorded in the SD card 80 may be loaded in the RAM 112 and may also be executed. The SD card 80 may be substituted by other recording media (e.g., a CD-ROM or a USB (Universal Serial Bus) memory). The type of recording medium that can be used instead of the SD card 80 is not limited. When another type of recording medium is used instead of the SD card 80, a hardware component corresponding to the other type of recording medium is to be used instead of the SD card slot 17.

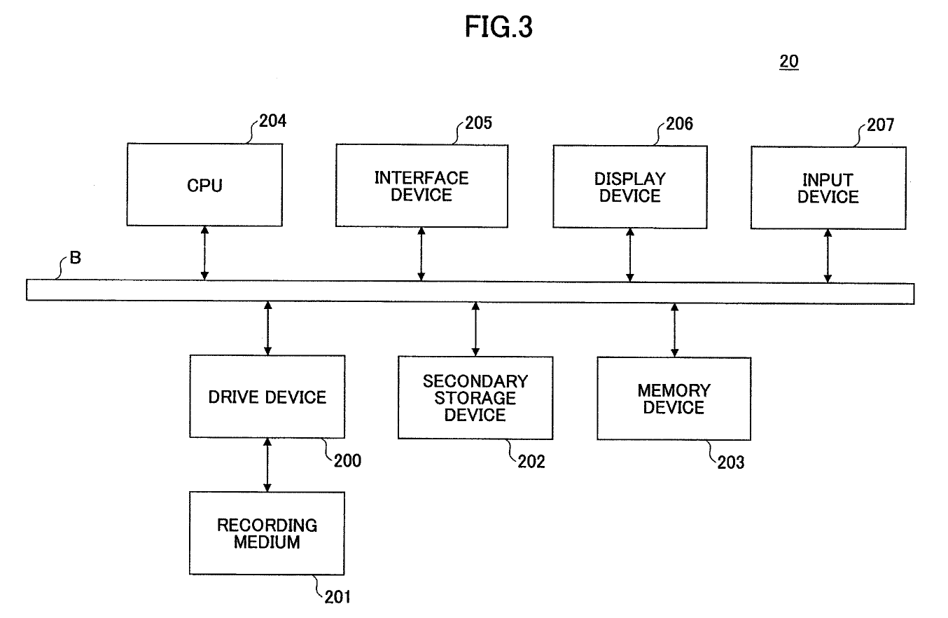

FIG. 3 illustrates a hardware configuration of the user terminal 20 according to an embodiment of the present invention. As shown in FIG. 3, the user terminal 20 includes a drive device 200, a secondary storage device 202, a memory device 203, a CPU 204, an interface device 205, a display device 206, and an input device 207, which are connected to each other by a bus B.

A program for implementing a process at the user terminal 20 may be provided in a recording medium 201 such as a CD-ROM or a memory card. When the recording medium 201 with a recorded program is inserted in the drive device 200, the program is installed in the secondary storage device 202 via the drive device 200. However, the program may not necessarily be installed from the recording medium 201, but may be downloaded from another computer via a network. The secondary storage device 202 stores the installed program together with necessary files and data.

When an instruction to activate a program is received, the memory device 203 reads the program from the secondary storage device 202 and stores the program. The CPU 204 implements functions pertaining to the user terminal 20 in accordance with programs stored in the memory device 203. The interface device 205 includes various interfaces used for communications, such as an interface for connecting to the network, an interface for connecting to the USB (Universal Serial Bus), and an interface for wireless communications such as Bluetooth. The display device 206 displays a GUI (Graphical User Interface) according to a program. The input device 207 includes a keyboard, a pointing device such as a mouse, or buttons, used for inputting various operation instructions.

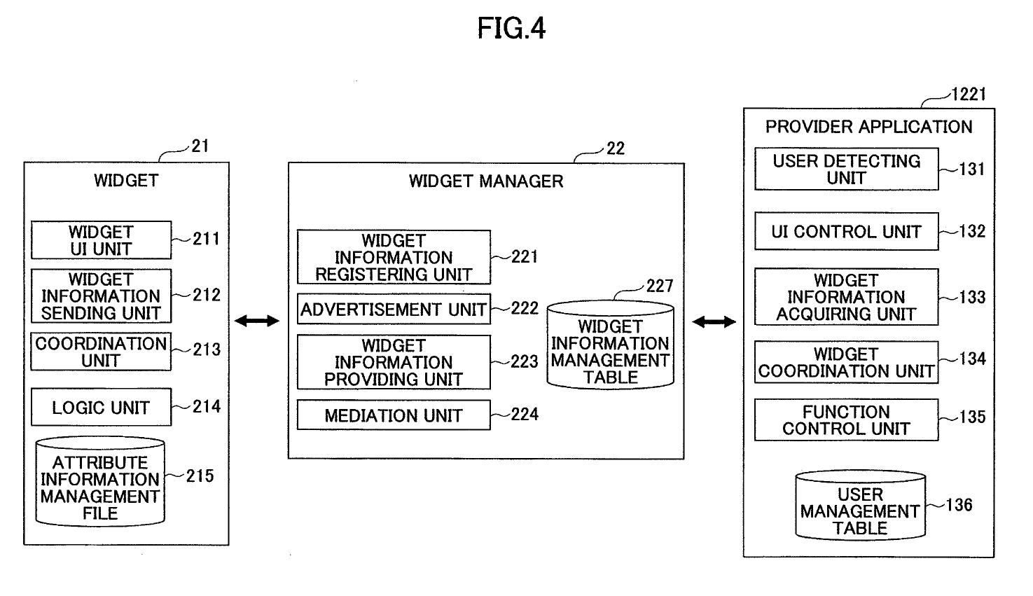

Next, a detailed description is given of the widget 21, the widget manager 22, and the provider application 1221. FIG. 4 illustrates functional configurations of the widget 21, the widget manager 22, and the provider application 1221.

As shown in FIG. 4, each widget 21 includes a widget UI unit 211, a widget information sending unit 212, a coordination unit 213, a logic unit 214, and an attribute information management file 215.

The widget UI unit 211 performs various display control operations and input control operations pertaining to the widget 21. When the widget 21 is activated, the widget information sending unit 212 sends a request to register widget information (attribute information of the widget 21) to the widget manager 22. The coordination unit 213 controls communications (exchange of information) for coordination with the provider application 1221. The attribute information management file 215 is a file for storing attribute information of the widget 21. The attribute information includes setting information for the widget 21. The setting information is an assembly of parameters specifying the behavior of the widget 21 or contents of a job executed by the widget 21. The logic unit 214 is a part where a function unique to each widget 21 is installed. For example, the logic unit 214 of the print widget 21A executes a process for causing the image forming apparatus 10 to execute a print job based on print data that has been generated for a predetermined logical printer. The logic unit 214 of the scan widget 21B executes a process for generating the layout of an image that is expressed by image data obtained by a scanning process.

Among the elements included in the widget 21, to distinguish those belonging to the print widget 21A from those belonging to the scan widget 21B, “A” is appended to reference numerals of elements of the print widget 21A and “B” is appended to reference numerals of elements of the scan widget 21B. For example, the logic unit 214 of the print widget 21A is expressed as “logic unit 214A”.

The widget manager 22 includes a widget information registering unit 221, an advertisement unit 222, a widget information providing unit 223, a mediation unit 224, and a widget information management table 227.

The widget information registering unit 221 receives a request to register widget information from the widget 21, and saves the widget information in the widget information management table 227. The widget information management table 227 is for registering widget information of each widget 21 that is activated in the user terminal 20. The widget information management table 227 is recorded in the secondary storage device 202.

The advertisement unit 222 advertizes (broadcasts or multicasts), on the network, widget information such as a user ID received from the widget information registering unit 221. The advertisement is issued in units of users (use IDs). Accordingly, an advertisement of the advertisement unit 222 may be information for reporting to the image forming apparatus 10 that there is a new user who can use one of the widgets 21.

In response to the requests from the image forming apparatus 10, the widget information providing unit 223 provides the image forming apparatus 10 with (sends) widget information registered in the widget information management table 227. The mediation unit 224 mediates or relays communications between the widget 21 and the provider application 1221.

The provider application 1221 includes a user detecting unit 131, a UI control unit 132, a widget information acquiring unit 133, a widget coordination unit 134, a function control unit 135, and a user management table 136.

The user detecting unit 131 detects the presence of a user who can use the widget 21 based on an advertisement issued by the widget manager 22, and registers, in the user management table 136, the user ID included in the advertisement. The user management table 136 is for managing a list of users on the network who can use the widget 21.

The UI control unit 132 receives input of an operation instruction for a widget 21 from a user. That is to say, although the widget 21 is disposed in the user terminal 20, the widget 21 can be operated from the operations panel of the image forming apparatus 10. The widget information acquiring unit 133 acquires, from the widget manager 22, widget information of the widget 21 belonging to a user selected from among users registered in the user management table 136. The widget coordination unit 134 controls communications with the widget manager 22. The function control unit 135 controls the execution of a function requested by the widget 21. The process of implementing the function is transferred to the standard application 121 or another SDK application 122.

In the following, the parts unique to each of the print widget 21A and the scan widget 21B are described (however, there are some parts that are common to both). In a first embodiment of the present invention, the print widget 21A is described.

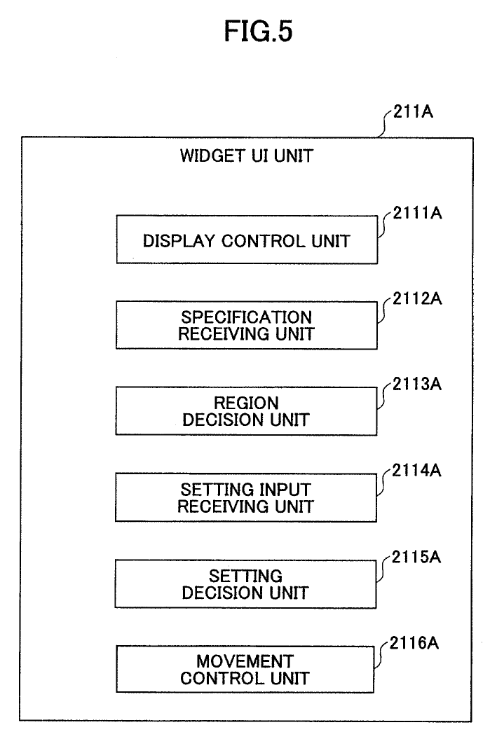

FIG. 5 illustrates a functional configuration of the widget UI unit 211A of the print widget 21A. As shown in FIG. 5, the widget UI unit 211A includes a display control unit 2111A, a specification receiving unit 2112A, a region decision unit 2113A, a setting input receiving unit 2114A, a setting decision unit 2115A, and a movement control unit 2116A.

The display control unit 2111A implements display control pertaining to the print widget 21A. For example, the display control unit 2111A displays an icon of the print widget 21A on a display screen page 300 of the display device 206. The icon of the widget 21 is for expressing the widget 21 as a single object on the display screen page. Operating the icon of the widget 21 on the display screen page virtually corresponds to operating the widget 21. Thus, in the following description, the “icon of the widget 21” is also referred to as the “widget 21” (print widget 21A or scan widget 21B).

The display screen page of the display device 206 displays the widget 21 and other icons (file icons) storing document data in various data formats managed in the file system of the OS 25.

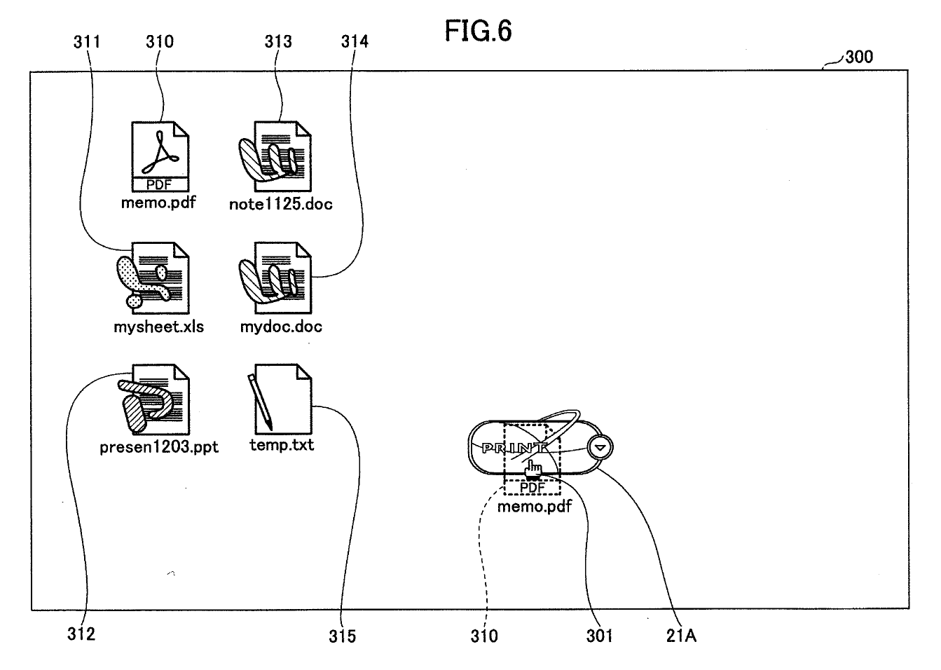

FIG. 6 illustrates examples of icons displayed on the display screen page according to the first embodiment. As shown in FIG. 6, the display screen page 300 includes the print widget 21A, file icons 310 through 314, and a pointer 301. The pointer 301 is a figure or an image that indicates the position of a mouse, which is one of the elements of the input device 207.

The icon of the widget 21 and the file icons may not only be formed with metaphors of predetermined processes or image data, but may also be formed with characters and/or symbols. An icon may be formed with one of or both of a figure and a character(s). In the present embodiment, a mouse is used as a specific example of a pointing device, but any other pointing device may be used. For example, a track pad, a track ball, and a touch panel may be used. Depending on the type of pointing device, there may be cases where the pointer 301 is not displayed.

The display control unit 2111A displays, on the display screen page 300, a setting window for receiving input of setting information for a job to be entered into the print widget 21A. The setting information corresponds to parameters specifying process contents of the print widget 21A when executing a job. A window is a virtual (software) screen page that is displayed on the display screen page 300 (hardware).

The specification receiving unit 2112A receives a job to be entered into the print widget 21A, and receives a specification of document data that is a processing target of the job. Specifically, when a file icon is dragged and dropped into the print widget 21A, the specification receiving unit 2112A recognizes that a job has been entered into the print widget 21A and document data that is a processing target of the job has been specified. That is to say, the document data corresponding to the file icon that has been dragged and dropped into the print widget 21A is the processing target of the job. FIG. 6 shows a state where the file icon 310 has been dragged and dropped into the print widget 21A.

The setting input receiving unit 2114A receives input of setting information via a setting window.

The region decision unit 2113A determines whether the pointer 301 is in a predetermined region (range). For example, the region decision unit 2113A compares the coordinates of the predetermined region with coordinates of the pointer 301 to make this decision.

The setting decision unit 2115A decides the setting information received by the setting input receiving unit 2114A when the region decision unit 2113A determines that the pointer 301 has moved out of the predetermined region and a predetermined time period has elapsed. The predetermined time period may be set at the attribute information management file 215A of the print widget 21A.

The movement control unit 2116A controls the movement of a display position of the print widget 21A on the display screen page 300. Specifically, when the movement control unit 2116A detects that a mouse button has been pressed while the pointer 301 is pointing at the print widget 21A, the movement control unit 2116A starts the moving process. As the pointer 301 is dragged while the mouse button is pressed (while the print widget 21A is being held), the movement control unit 2116A updates the position information (coordinate values) of the print widget 21A to the position of the pointer 301. As a result, the display position of the print widget 21A moves in accordance with the movement of the pointer 301.

A description is given of a process performed by the information processing system 1. Before using the widget 21, the user activates the widget manager 22 in the user terminal 20. First, a description is given of a process of activating the widget manager 22.

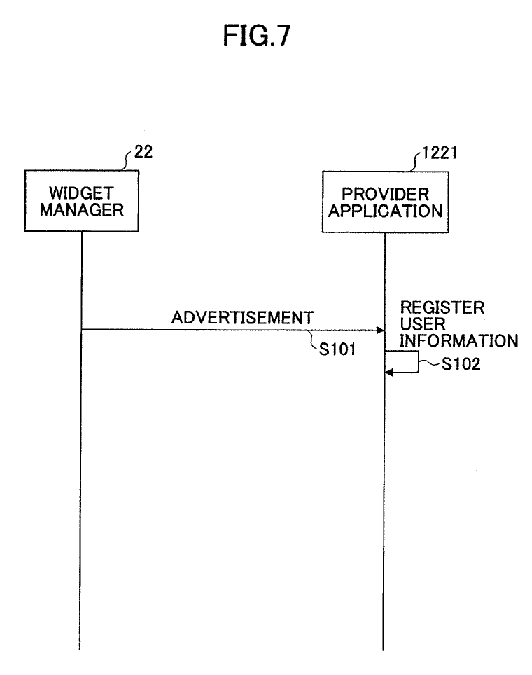

FIG. 7 is a sequence diagram for describing the process performed when the widget manager 22 is activated.

In response to an instruction from the user, or when the widget manager 22 is automatically activated, the advertisement unit 222 of the widget manager 22 sends, onto the network, an advertisement of user information including a user ID of the log-in user (a user who has logged in) and a URL for acquiring widget information (step S101).

Next, when the advertisement is received, the user detecting unit 131 of the provider application 1221 registers, in the user management table 136, the user ID and the URL for acquiring widget information included in the advertisement (step S102).

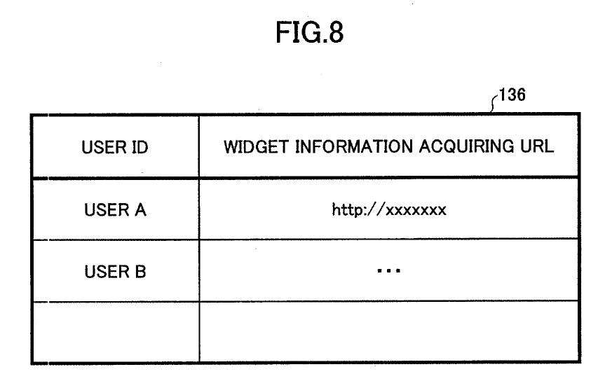

FIG. 8 illustrates an example of the user management table 136. As shown in FIG. 8, the user management table 136 manages pairs of user IDs and URLs for acquiring widget information (widget information acquiring URL). The widget information acquiring URL is unique to each widget manager 22. Each user terminal 20 only needs to activate one widget manager 22. Thus, the widget manager 22 is shared by plural widgets 21. In FIG. 8, records are registered for a user A and a user B. The user management table 136 may be stored in the HDD 114, for example.

After activating the widget manager 22, the user may use the print widget 21A or the scan widget 21B.

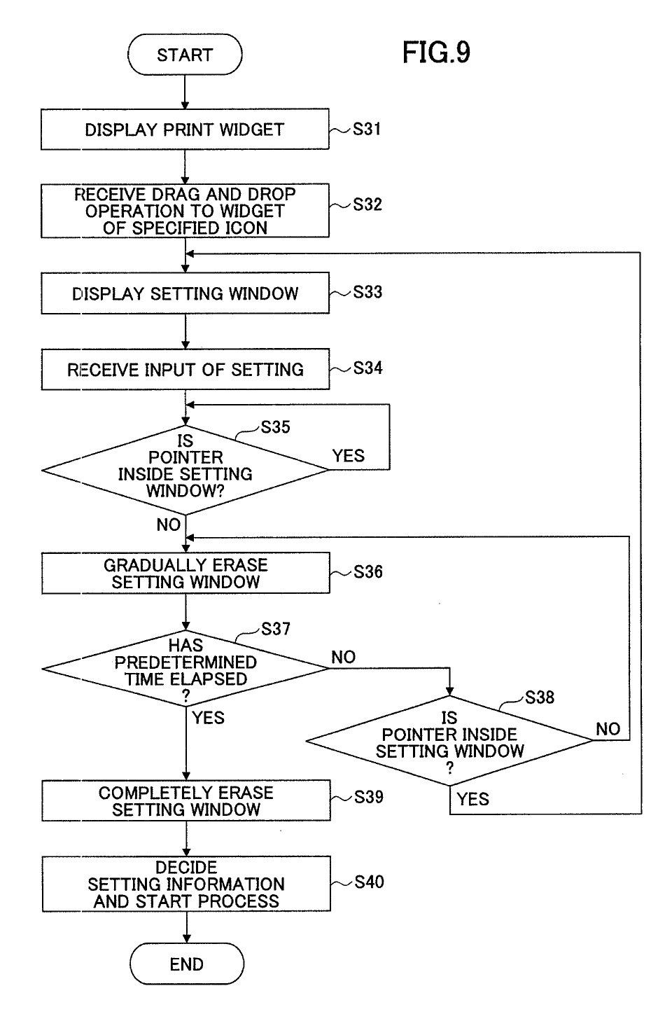

FIG. 9 is a flowchart of a process performed when a job has been entered into the print widget 21A.

When the print widget 21A is activated, the display control unit 2111A displays the print widget 21A on the display screen page 300 (step S31). Then, when the user operates the pointer 301 (mouse) to drag and drop a file icon into the print widget 21A as shown in FIG. 6, the specification receiving unit 2112A receives document data pertaining to the drag/dropped file icon as a target of a job (step S32). As a file icon is dropped, the display control unit 2111A displays a setting window on the display screen page 300 (step S33).

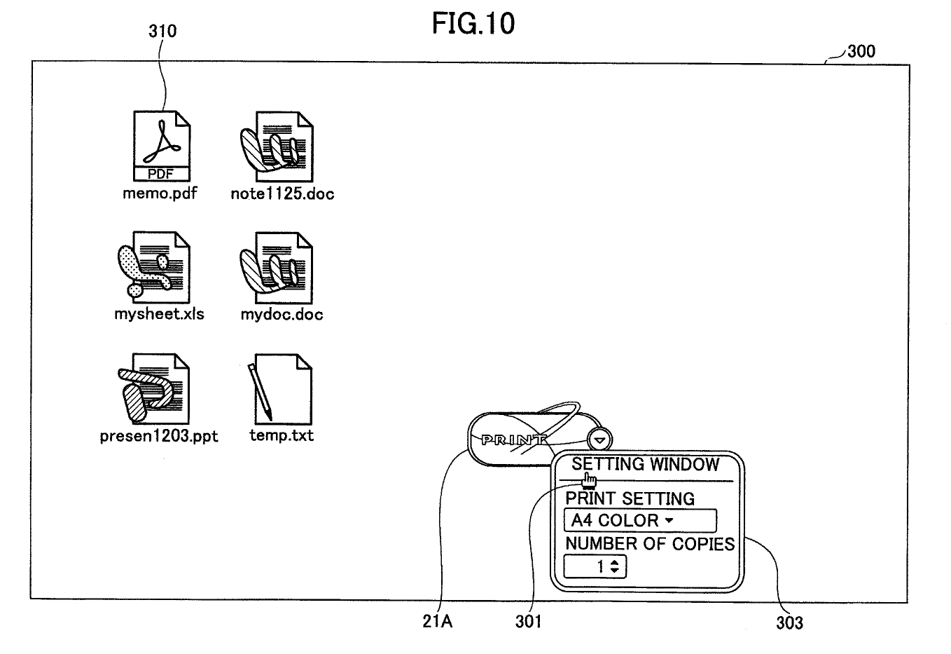

FIG. 10 illustrates a displayed setting window of the print widget 21A. As shown in FIG. 10, a setting window 303 is displayed near the widget UI unit 211A. The setting window 303 displays a print setting item and a copy number setting item. The print setting item is used for selecting the sheet size used for printing, and for selecting whether to perform color printing or monochrome printing. The copy number setting item is for selecting the number of copies to be printed out. Setting items other than the print setting item and the copy number setting item may be displayed in the setting window 303. The initial value displayed in the setting window 303 is acquired from the attribute information management file 215A of the print widget 21A.

Next, the setting input receiving unit 2114A receives a selection or an input of a setting value for each setting item (parameter) via the setting window 303 (step S34). The setting input receiving unit 2114A records the received setting values in the memory device 203.

Next, the region decision unit 2113A determines whether the pointer 301 is inside the display region of the setting window 303 (step S35). When the pointer 301 is inside the display region of the setting window 303 (Yes in step S35), the region decision unit 2113A controls the process to not proceed to the next step. Thus, the displayed state of the setting window 303 is maintained. Accordingly, the user can make changes in the setting values. When the setting values are changed, the changes are applied to the setting values recorded in the memory device 203.

Meanwhile, when the region decision unit 2113A detects that the pointer 301 has moved outside the display region of the setting window 303 (No in step S35), the display control unit 2111A gradually erases the setting window 303 (step S36).

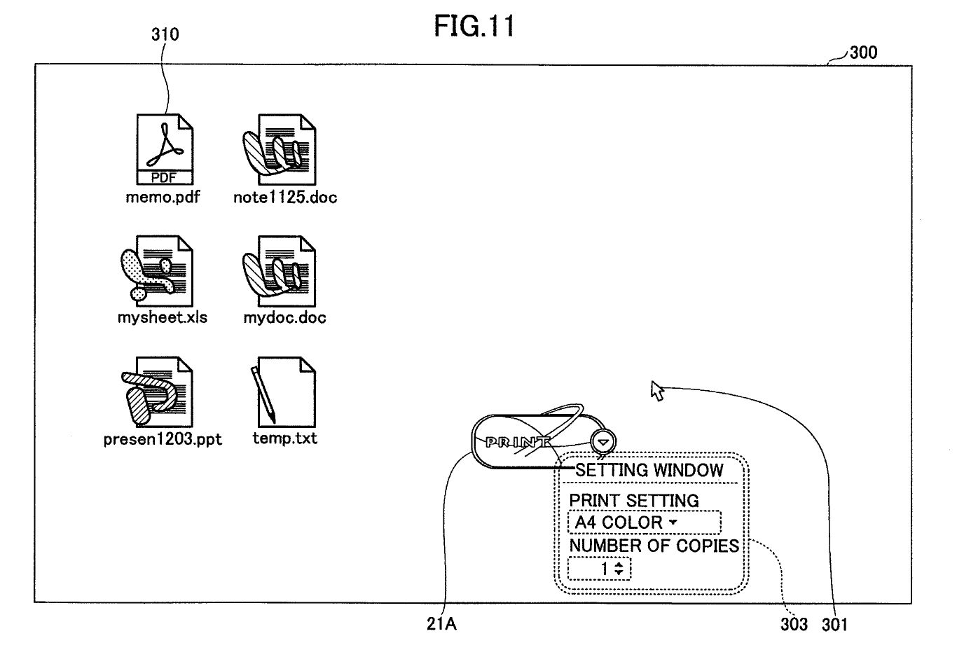

FIG. 11 illustrates the setting window 303 that is gradually being erased. In FIG. 11, the setting window 303 is depicted with dotted lines. This is to express that the setting window 303 is gradually being erased. “Gradually being erased” means the color used for rendering the setting window 303 is gradually fading, or the transparency of the setting window 303 is gradually increasing.

When the region decision unit 2113A detects that the pointer 301 has once again moved into the display region of the setting window 303 before a predetermined time period elapses after the region decision unit 2113A has detected that the pointer 301 has moved outside the display region of the setting window 303 (No in step S37 and Yes in step S38), the process returns to step S33. Thus, the setting window 303 is completely displayed once again. Accordingly, the user can make changes in the setting values. When the setting values are changed, the changes are applied to the setting values recorded in the memory device 203.

When a predetermined time period has elapsed after the region decision unit 2113A has detected that the pointer 301 has moved outside the display region of the setting window 303 (Yes in step S37), the display control unit 2111A completely erases the setting window 303 (step S39).

Next, the setting decision unit 2115A decides the setting information with the setting value recorded in the memory device 203 (step S40). In response to the decision of the setting information, the print widget 21A starts a process based on the setting information for the document data that is the processing target.

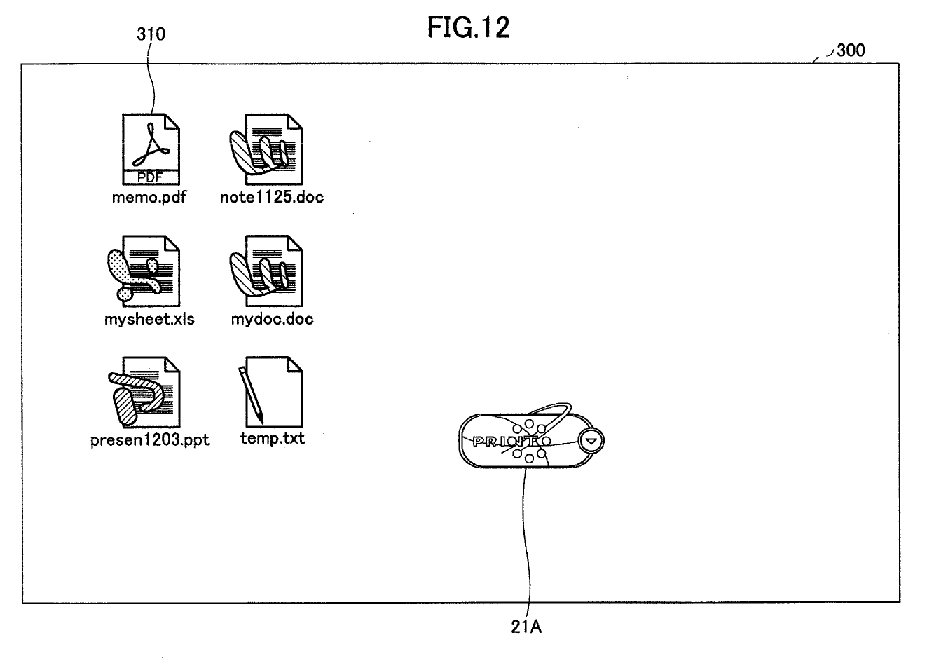

In response to the decision of the setting information, the display state of the print widget 21A may change, as shown in FIG. 12.

FIG. 12 illustrates an example of the displayed print widget 21A when the setting information has been decided. As shown in FIG. 12, a circle formed with eight dots is superposed on the print widget 21A. By viewing this circle, the user can visually confirm that the process has started.

The setting window 303 is displayed when a file icon is dragged and dropped into the print widget 21A, and is not displayed when the pointer 301 has moved outside the display region of the setting window 303. Thus, the user can decide the setting information without clicking an OK button or a decision button. Accordingly, the user can enter a job into the print widget 21A by a simple operation.

Even after the region decision unit 2113A determines that the pointer 301 is outside the display region of the setting window 303, if the pointer 301 is once again moved into the display region of the setting window 303 before a predetermined time period has elapsed, the setting window 303 is displayed once again. This enhances the operability when the user wants to reset the setting values. However, the setting window 303 may be configured to be immediately erased after the pointer 301 has moved outside the display region of the setting window 303, and the setting information may be immediately decided.

Next, a description is given of a process that is executed in response to the decision of the setting information in step S40 of FIG. 9.

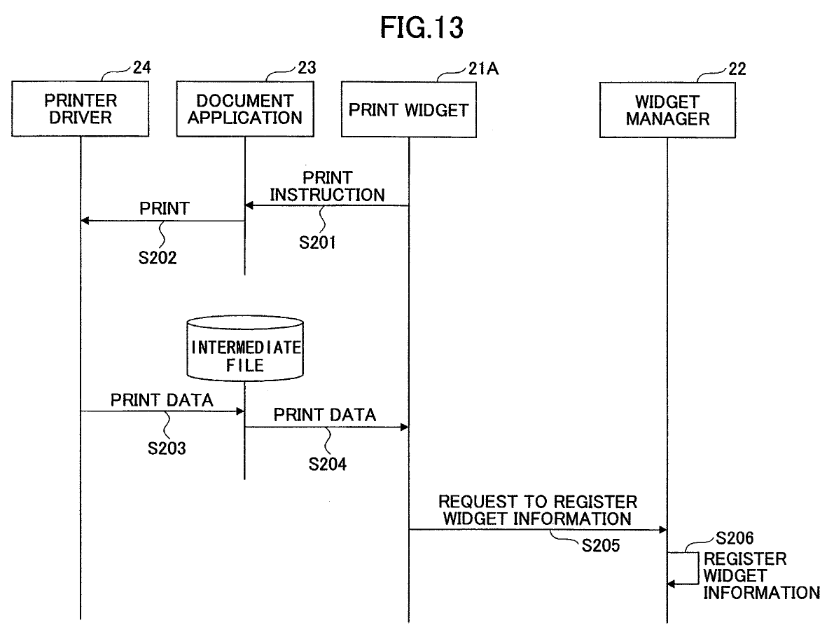

FIG. 13 is a sequence diagram for describing a process of the print widget 21A after the setting information has been decided.

In response to the decision of the setting information, the print widget 21A inputs, to the OS 25, a command line indicating a print instruction for the document application 23. In the command line, the file name of the dragged/dropped file icon is included as the argument (step S201). As a result, the document application 23 is activated in the background. As the document application 23 is activated, the document application 23 inputs a request to print the document data to the printer driver 24 (step S202). In response to the print request, the printer driver 24 generates print data (PDL (Page Description Language) data) of the document data. When a logical printer corresponding to the print widget 21A is specified as the print destination, the printer driver 24 generates an intermediate file having a predetermined file name set as the output destination for the logical printer, and outputs the print data to the intermediate file (step S203).

Meanwhile, after the print widget 21A is activated, the print widget 21A waits for an intermediate file having the predetermined file name to be generated. Specifically, the print widget 21A performs polling for the file having the predetermined name in a predetermined folder, to determine the presence of an intermediate file. When the print widget 21A detects that an intermediate file has been generated, the print widget 21A reads print data from the intermediate file (step S204).

In the user terminal 20, a plurality of print widgets 21A may be activated. In this case, one logical printer is to be set for each of the print widgets 21A, and the intermediate files output from the logical printers are to have different file names. Each print widget 21A waits for an intermediate file to be output from a corresponding logical printer, so that plural print widgets 21A do not have to compete for the same intermediate file. For example, it may be advantageous to activate plural print widgets 21A so that different setting information can be set in the print widgets 21A, and the print widget 21A to be used can be switched according to the desired print format. The user would only need to select the logical printer corresponding to the desired print widget 21A, in order to select the print widget 21A to be used.

Next, the widget information sending unit 212A sends, to the widget manager 22, a request to register widget information including the decided setting information as well as the print data acquired by polling (step S205). The widget information of the print widget 21A corresponds to attribute information of the job that has been entered. Each widget 21 has pre-registered identification information (for example, the URL (Uniform Resource Locator) of the widget manager 22) used for communicating with the widget manager 22.

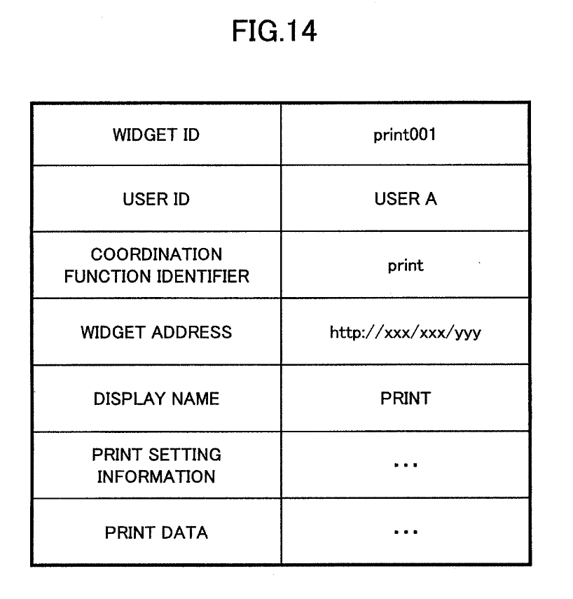

FIG. 14 illustrates an example of widget information of the print widget 21A. As shown in FIG. 14, the widget information of the print widget 21A includes a widget ID, a user ID, a coordination function identifier, a widget address, a display name, setting information, and print data.

The widget ID is identification information for uniquely identifying each widget 21. The user ID is identification information of the user who owns the print widget 21A. The coordination function identifier is for identifying the required function (i.e., the function to be used by the print widget 21A) of the image forming apparatus 10 that is to coordinate with the print widget 21A. Examples of the coordination function identifier are “print” and “scan”, where “print” indicates a print function and “scan” indicates a scan function. The print widget 21A uses the print function of the image forming apparatus 10. Therefore, in the example shown in FIG. 14, “print” is the coordination function identifier. The widget address is identification information (for example, a URL) for uniquely identifying each widget in network communications. The display name is a character string for displaying the name of the print widget 21A.

The setting information is the setting information that has been decided for the print widget 21A. The print data is the print data that has been acquired by polling.

The widget information that is sent by the widget information sending unit 212A of the print widget 21A in step 5205 is received by the widget information registering unit 221 of the widget manager 22. The widget information registering unit 221 registers the widget information in the widget information management table 227 corresponding to the user ID included in the received widget information (step S206). The print widget 21A resumes polling for the intermediate file after the widget information has been registered.

After a job has been entered into the print widget 21A in the user terminal 20, the user moves to the location where the image forming apparatus 10 is installed to cause the image forming apparatus 10 to execute the job. When plural image forming apparatuses 10 are connected to the network, the same advertisement is received by the user detecting units 131 of the plural image forming apparatuses 10, and the user ID and the URL for acquiring widget information are registered in the user management table 136 of each of the image forming apparatuses 10. Therefore, as long as the image forming apparatus 10 has a printing function, the job can be executed from any one of the image forming apparatuses 10.

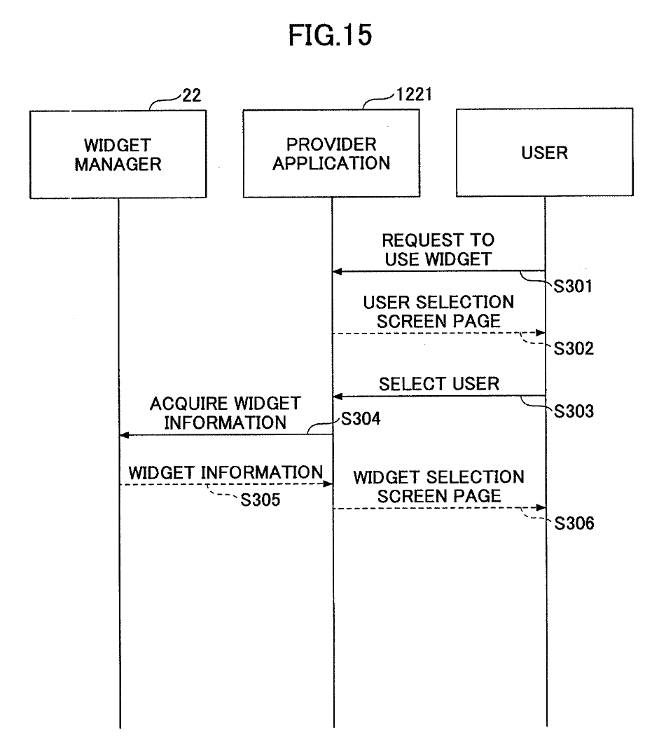

Next, a description is given of a process that is executed according to user operation at the image forming apparatus 10. FIG. 15 is a sequence diagram for describing the process of displaying a list of widgets that can be executed.

When a user inputs an instruction for using the provider application 1221 via the operations panel 15 (step S301), the UI control unit 132 of the provider application 1221 displays a user selection screen page on the operations panel 15 based on information registered in the user management table 136 (step S302).

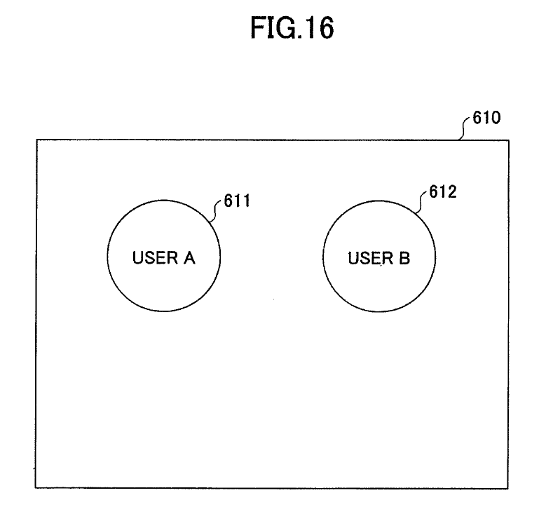

FIG. 16 illustrates a displayed user selection screen page. A user selection screen page 610 shown in FIG. 16 displays buttons for each of the user IDs. In FIG. 16, a button 611 corresponding to a user A and a button 612 corresponding to a user B are displayed.

Next, the user presses a button corresponding to his or her own user ID on the user selection screen page 610 (step S303). When the button is pressed, the widget information acquiring unit 133 acquires, from the user management table 136, a URL for acquiring widget information associated with the user ID corresponding to the selected button. The image forming apparatus 10 may be configured to perform user authentication when the button corresponding to the user ID is pressed, and execute subsequent processes only when the user has been authenticated.

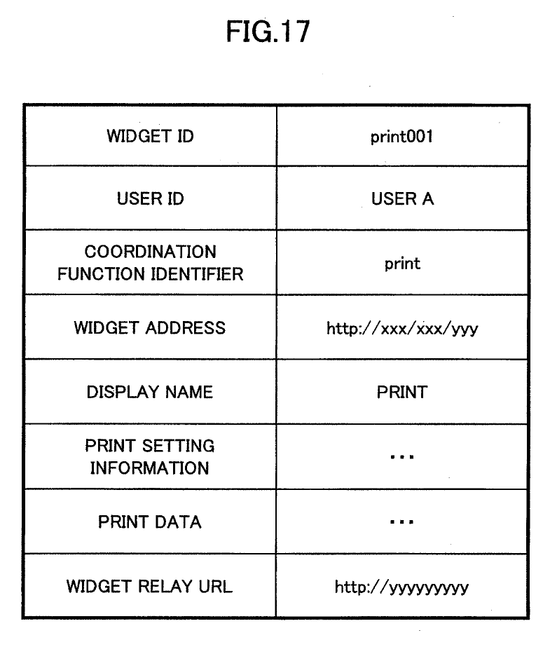

Next, the widget information acquiring unit 133 sends a request to acquire the widget information to the URL for acquiring widget information corresponding to the selected user ID (S304). The request to acquire widget information is received by the widget information providing unit 223 of the widget manager 22. The widget information providing unit 223 acquires a list of widget information items registered in the widget information management table 227 corresponding to the URL for acquiring widget information (i.e., the widget information management table 227 corresponding to the user operating the image forming apparatus 10), and returns the list to the provider application 1221 (step S305). When sending the list of widget information items, the widget information providing unit 223 generates, for each widget (for each widget information item), a unique URL for relaying communications between the provider application 1221 and each widget 21 (hereinafter, “widget relay URL”). The widget information providing unit 223 appends a widget relay URL generated for each widget to the widget information of the corresponding widget, and sends, to the provider application 1221, a list of widget information items to which widget relay URLs have been appended. Thus, the widget information sent at step S305 has a configuration as illustrated in FIG. 17.

FIG. 17 illustrates a configuration of widget information of the print widget 21A that is sent from the widget manager 22 to the provider application 1221.

The widget information shown in FIG. 17 is formed by appending a widget relay URL to the widget information shown in FIG. 14. In step S305, a list of widget information items (widget information list) as shown in FIG. 17 is sent to the provider application 1221. Even when the widget information list only includes one widget information item, the widget information list is still referred to as a list. As described below, when the scan widget 21B is activated in the user terminal 20, the list will include widget information items of the scan widget 21B.

Next, the UI control unit 132 of the provider application 1221 stores the received widget information list in the RAM 112, and displays a screen page (widget selection screen page) including a list of widgets 21 that the user can use, based on the widget information list (step S306).

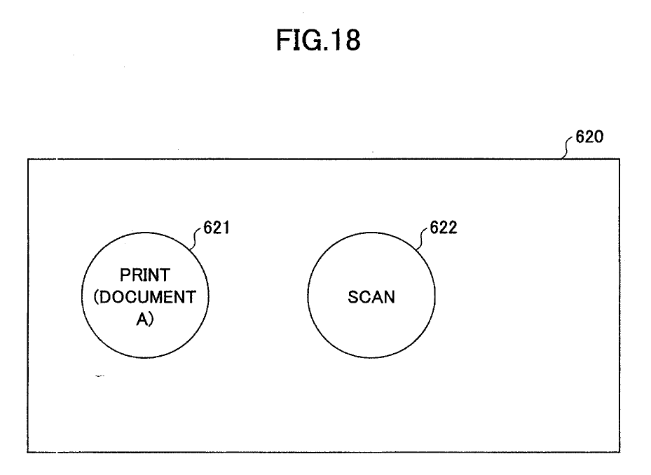

FIG. 18 illustrates a displayed widget selection screen page. A widget selection screen page 620 shown in FIG. 18 is displaying buttons for each of the widgets. In FIG. 18, a button 621 corresponding to a job relevant to a document A of the print widget 21A and a button 622 corresponding to the scan widget 21B are displayed. That is to say, FIG. 18 illustrates the displayed widget selection screen page 620 when widget information corresponding to a job relevant to a document A of the print widget 21A and widget information of the scan widget 21B are received at step S305 in FIG. 15.

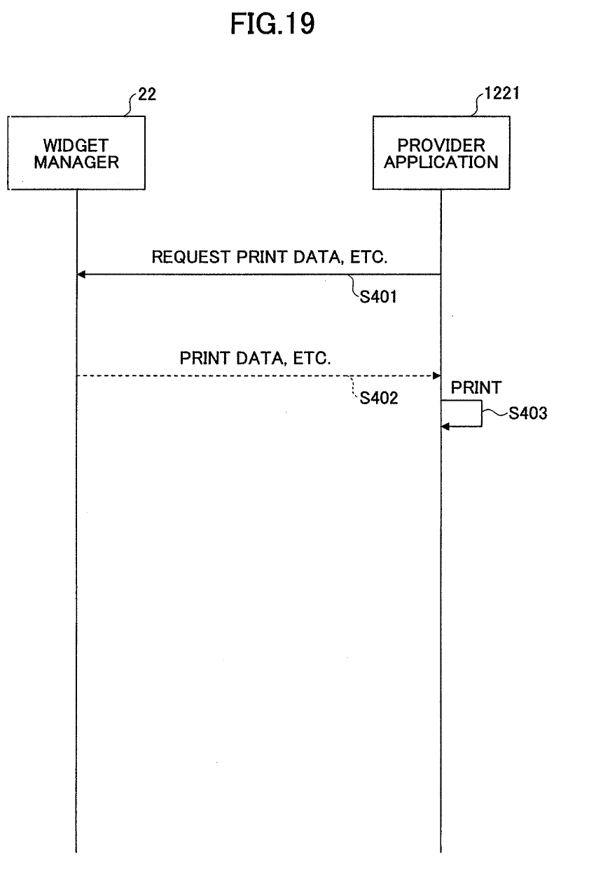

When the button 621 of the widget selection screen page 620 is pressed and the start key of the operations panel 15 is pressed, a process illustrated in FIG. 19 starts.

FIG. 19 is a sequence diagram for describing the process of executing the print widget 21A.

The widget coordination unit 134 recognizes that printing is to be executed based on a coordination function identifier (“printer”) included in widget information (hereinafter, “current widget information”) corresponding to the pressed button 621. In order to execute printing, the image forming apparatus 10 needs to obtain print data and setting information. Accordingly, the widget coordination unit 134 sends, to the widget relay URL included in the current widget information, a request to send print data and setting information (step S401).

The request to the widget relay URL to send print data and setting information is received by the mediation unit 224 of the widget manager 22. The mediation unit 224 acquires print data and setting information from the widget information corresponding to the widget relay URL, from among the widget information items registered in the widget information management table 227. The mediation unit 224 returns the acquired print data and setting information to the widget coordination unit 134 of the provider application 1221 (step S402).

The widget coordination unit 134 inputs the received print data and setting information in the function control unit 135. Then, the function control unit 135 causes the print application 1212 to execute a print job based on the input print data and setting information (step S403). As a result, a sheet having a print image based on the setting information and the print data is output from the printer 13.

Next, a description is given of a second embodiment of the present invention. In the second embodiment, a description is given of operations of the scan widget 21B.

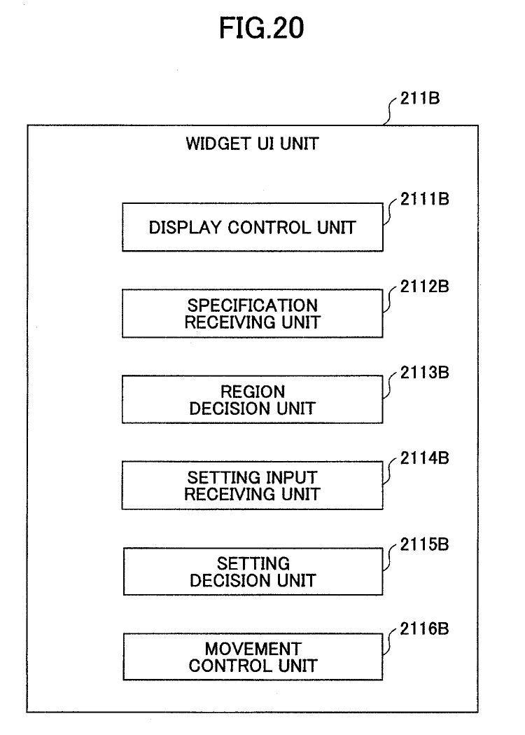

FIG. 20 illustrates a functional configuration of the widget UI unit 211B of the scan widget 21B. As shown in FIG. 20, the widget UI unit 211B includes a display control unit 2111B, a region decision unit 2113B, a setting input receiving unit 2114B, a setting decision unit 2115B, and a movement control unit 2116B.

The display control unit 2111B implements display control pertaining to the scan widget 21B. For example, the display control unit 2111B displays an icon of the scan widget 21B and a setting window on the display screen page 300 of the display device 206. The setting input receiving unit 2114B receives input of setting information via a setting window. The region decision unit 2113B determines whether the pointer 301 is in a predetermined region (range). The setting decision unit 2115B decides the setting information received by the setting input receiving unit 2114B when the region decision unit 2113B determines that the pointer 301 has moved out of the predetermined region and a predetermined time period has elapsed. The movement control unit 2116B controls the movement of a display position of the scan widget 21B on the display screen page 300.

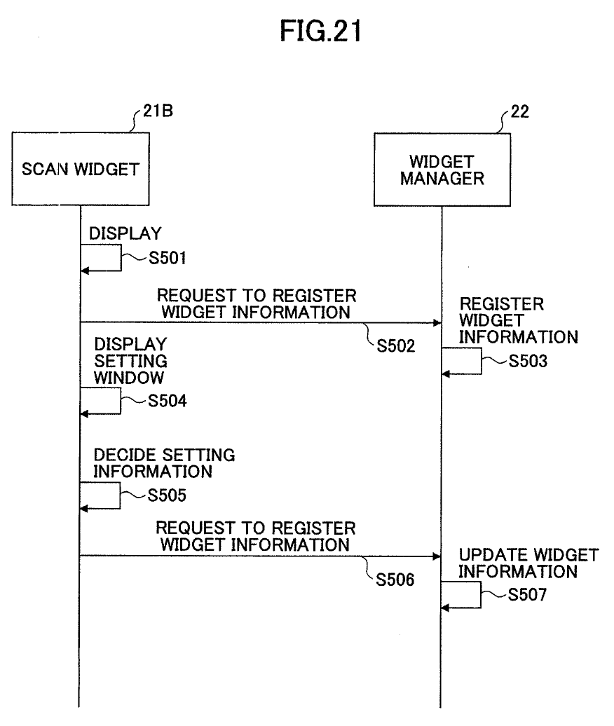

FIG. 21 is a sequence diagram for describing the process performed when the scan widget 21B is activated.

In response to an instruction to activate the scan widget 21B, which is input by a user at the user terminal 20, the display control unit 2111B of the scan widget 21B displays the scan widget 21B on the display screen page 300 (step S501).

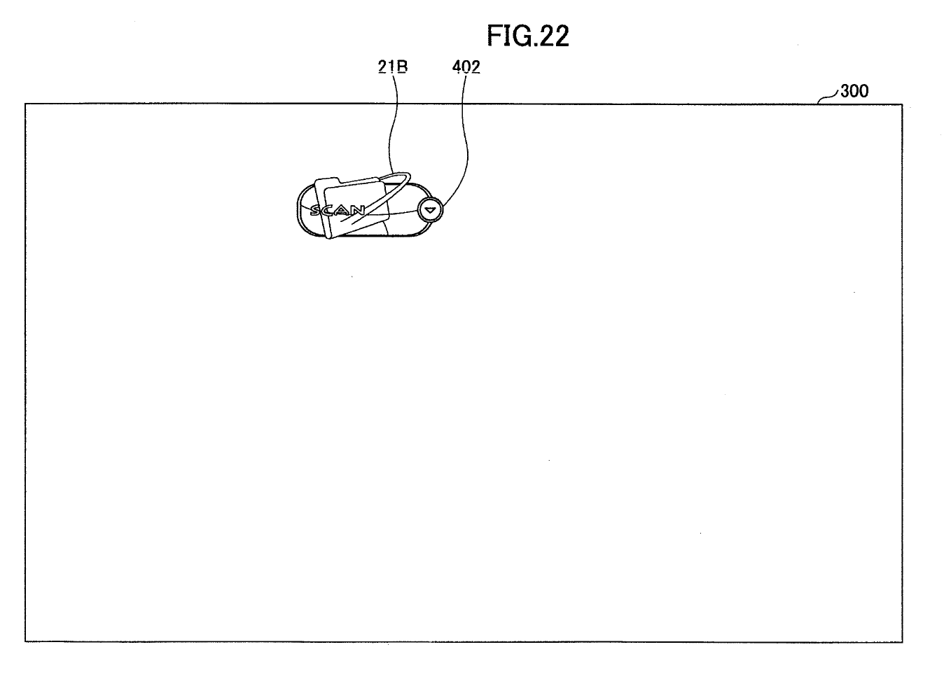

FIG. 22 illustrates a displayed scan widget 21B. The scan widget 21B displayed on the display screen page 300 includes a job list open/close button 402. Details of the job list open/close button 402 are given below. In the present embodiment, the relative size of the scan widget 21B with respect to the display screen page 300 is illustrated larger than the actual size, as a matter of convenience for description.

Next, the widget information sending unit 212B of the scan widget 21B acquires widget information from the attribute information management file 215B, and sends, to the widget manager 22, a request to register the widget information (step S502).

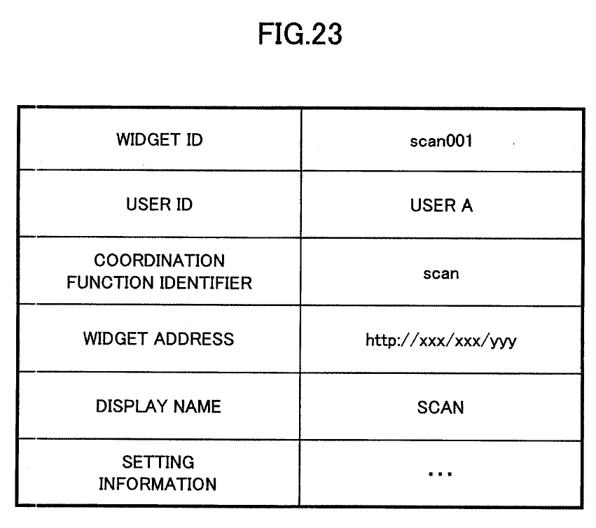

FIG. 23 illustrates an example of widget information of the scan widget 21B. The widget information shown in FIG. 23 has substantially the same configuration as the widget information of the print widget 21A described with reference to FIG. 14. However, the widget information of the scan widget 21B does not include print data. Furthermore, the configuration of the setting information for the scan widget 21B is different from the setting information for the print widget 21A. Furthermore, the scan widget 21B uses the scan function of the image forming apparatus 10. Therefore, the value of the coordination function identifier is “scan”.

In step S502, the widget information sent by the widget information sending unit 212B of the scan widget 21B is received by the widget information registering unit 221 of the widget manager 22. The widget information registering unit 221 registers the widget information in the widget information management table 227 corresponding to the user ID included in the received widget information (step S503).

By performing the above process, the widget information of the scan widget 21B is registered in the widget manager 22. However, there may be cases where the user wants to change the setting information of the scan widget 21B after the widget information is registered. In this case, the user single-clicks the mouse when the pointer 301 is pointing the scan widget 21B (parts except for the job list open/close button 402) on the display screen page 300. In response to the single-clicking operation, the display control unit 2111B displays a setting window (step S504).

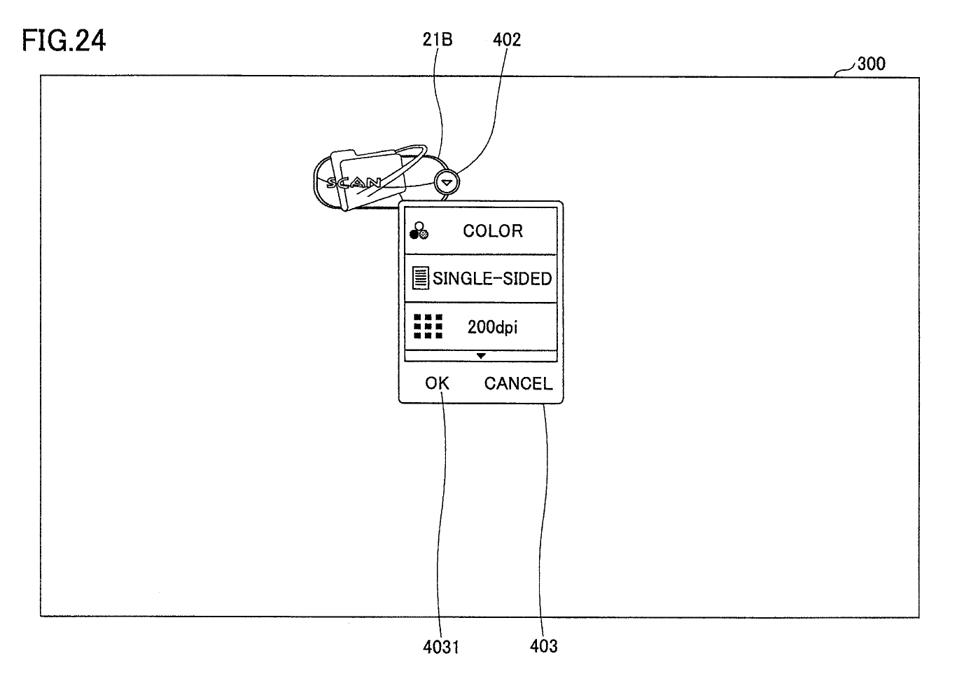

FIG. 24 illustrates a displayed setting window of the scan widget 21B. In a setting window 403 shown in FIG. 24, settings can be made for setting items including the color, double-sided scanning, and resolution, as setting information for a scanning operation. When any of the setting items are specified, a setting value selection menu is displayed, in which selection candidates of setting values are listed. When any of the setting values in the setting value selection menu is selected, the specification receiving unit 2112B updates the setting value loaded in the memory device 203 with the selected setting value, and applies the updated setting value to the setting window 403. In the initial state of the setting window 403, the setting values included in the setting information recorded in the attribute information management file 215B are loaded in the memory device 203 as initial values of the setting items, and the loaded setting values are displayed in the setting window 403.

When the setting value has been changed in the setting window 403 and an OK button 4031 is clicked, the setting decision unit 2115B decides the setting information with the setting value recorded in the memory device 203 (step S505). In response to the decision of the setting information, the widget information sending unit 212 of the scan widget 21B sends, to the widget manager 22, a request to register the widget information including the updated setting information (step S506). In the widget information registering unit 221 of the widget manager 22, the widget information that has already been registered in the widget information management table 227 is updated to the received widget information (step S507). The target of update is the widget information having the same widget ID as the received widget information.

Subsequently, the user moves to the location where the image forming apparatus 10 is installed to cause the image forming apparatus 10 to execute the scan widget 21B. Similar to the case of the print widget 21A, an advertisement is received in the network, so that the scan widget 21B can be executed from any of the plural image forming apparatuses 10 provided with a scan function.

The same process as described with reference to FIG. 15 is executed until the widget selection screen page 620 is displayed, by performing an operation via the operations panel 15 of the image forming apparatus 10. By performing the process of FIG. 15, the widget information of the scan widget 21B registered in the widget manager 22 is transferred to the image forming apparatus 10. The widget information is formed by appending a widget relay URL to the widget information shown in FIG. 23. Based on the widget information, the button 622 corresponding to the scan widget 21B is displayed on the widget selection screen page 620 as illustrated in FIG. 18.

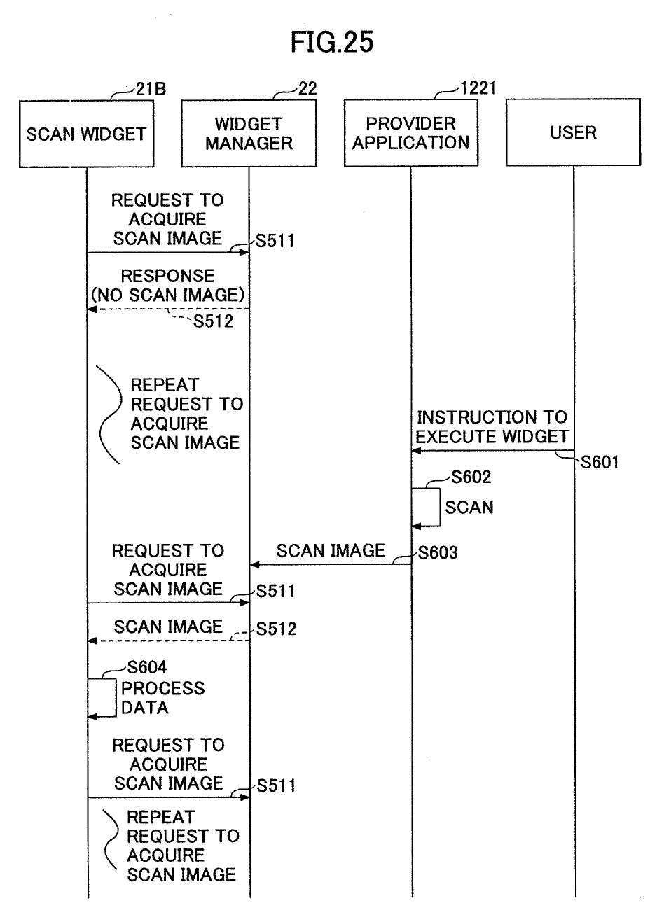

A description is given of a process relevant to the scan widget 21B after the widget selection screen page 620 has been displayed. FIG. 25 is a sequence diagram for describing the process performed when executing the scan widget 21B.

When at least one original is set in the image forming apparatus 10, and the button 622 corresponding to the scan widget 21B is selected in the widget selection screen page 620 (step S601), the widget coordination unit 134 of the provider application 1221 recognizes that scanning is to be executed based on the coordination function identifier (“scan”) included in the widget information (hereinafter, “current widget information”) corresponding to the pressed button 622.

The function control unit 135 causes the scan application 1211 to execute a scan job based on the setting information included in the current widget information (step S602). The scan application 1211 causes the scanner 12 to scan the original set in the image forming apparatus 10, and outputs the image data obtained as a result of the scanning process (hereinafter, “scan image data”) to the widget coordination unit 134.

The widget coordination unit 134 sends the can image data to the widget relay URL included in the current widget information (step S603). The scan image data sent to the widget relay URL is received by the mediation unit 224 of the widget manager 22.

Meanwhile, after sending the widget information, the scan widget 21B performs polling to confirm whether the image data has been obtained as a result of the scanning process in the image forming apparatus 10, and waits for the image data to be transferred (returned). Specifically, the coordination unit 213B of the scan widget 21B sends a request to acquire the image data obtained from the scanning process (scan image data), to the mediation unit 224 of the widget manager 22 (step S511). The mediation unit 224 responds to this request (step S512).

The mediation unit 224 receives the request to acquire the scan image data after receiving the scan image data (step S511), and returns, to the coordination unit 213B of the scan widget 21B, the scan image data received at the widget relay URL of the scan widget 21B making the request (step S512).

When the scan image data is received, the coordination unit 213B inputs the scan image data in the logic unit 214B. The logic unit 214B executes a process (logic) that is installed in the logic unit 214B, on the scan image data (step S604). Specifically, the logic unit 214B generates a file in a folder set in the attribute information management file 215B, and outputs the scan image data to the generated file. Next, to be prepared for the execution of the next scan widget 21B, the attribute information management file 215B resumes polling by making scan image data acquiring requests (step S511), and waits for scan image data to be transferred.

The scan image data that is stored in the user terminal 20 by the scan widget 21B can be operated via the scan widget 21B displayed on the display screen page 300. Specifically, when the job list open/close button 402 is clicked, the display control unit 2111B displays a job list window.

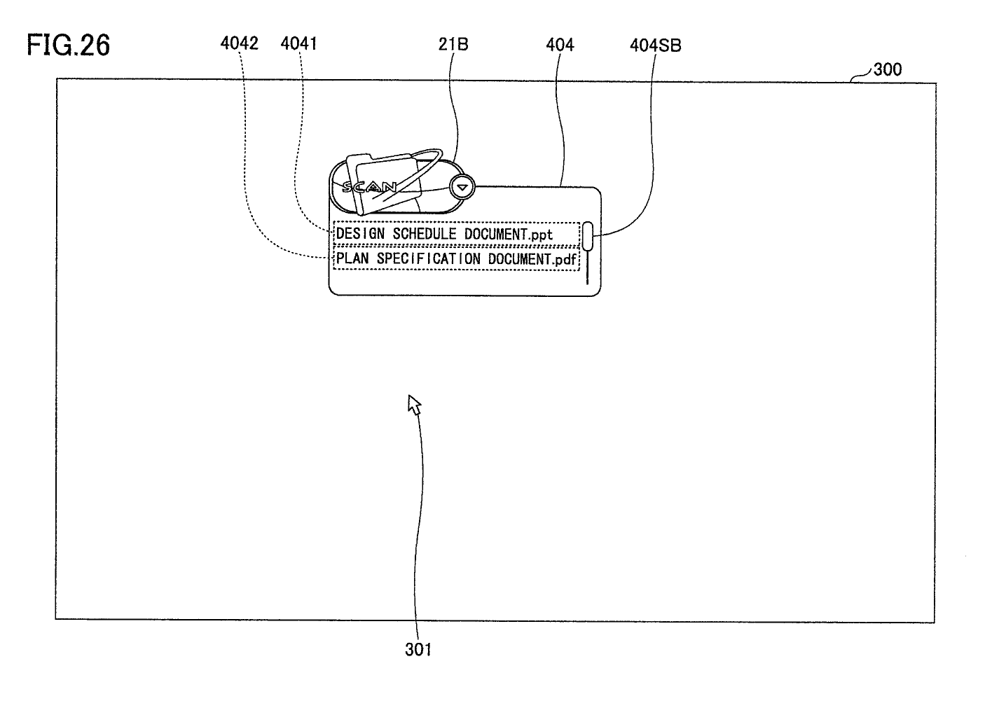

FIG. 26 illustrates a displayed job list window. As shown in FIG. 26, a job list window 404 is displaying two file names of scan image data. Specification regions 4041 and 4042 (scan image data specification regions) indicated by rectangles depicted with dotted lines correspond to the ranges where the first scan image data and the second scan image data are specified, respectively. The dotted lines are shown as a matter of convenience for description. A scroll bar 404SB is for scrolling up and down a list of file names when there is a large number of stored scan image data items. In the job list window 404, regions other than the scan image data specification regions and the scroll bar 404SB are referred to as “blank regions”.

By referring to the job list window 404, the user can confirm the scan image data items that are presently stored. By clicking the job list open/close button 402 while the job list window 404 is displayed, the display control unit 2111B closes (hides) the job list window 404.

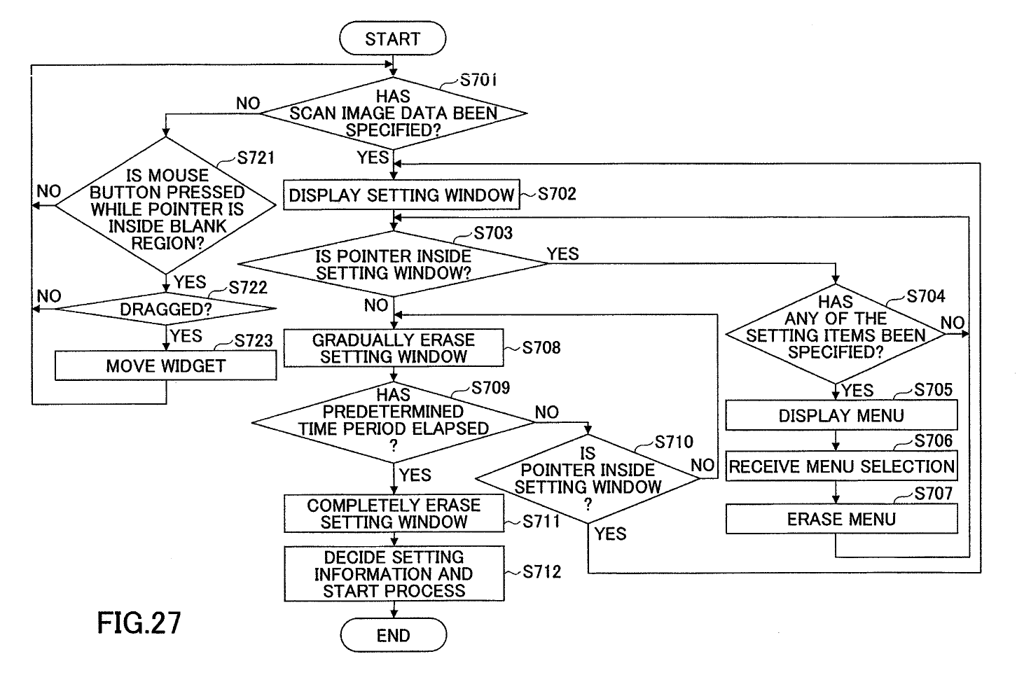

Next, a description is given of a process that is executed in accordance with operations in the job list window 404. FIG. 27 is a flowchart of a process performed in accordance with operations in the job list window 404.

When one of the scan image data specification regions is indicated by the pointer 301 (Yes in step S701), the display control unit 2111B displays, on the display screen page 300, a setting window relevant to the specified scan image data (hereinafter, “current image data”) (step S702). The indication by the pointer 301 may be decided when the pointer 301 has entered one of the specification regions, or when a single click is executed while the pointer 301 is in one of the specification regions. Furthermore, when a single click is executed while the pointer 301 is in one of the specification regions, a file storing the scan image data may open (i.e., the scan image data may be displayed). In this case, the setting window is preferably displayed when the pointer 301 has entered one of the specification regions.

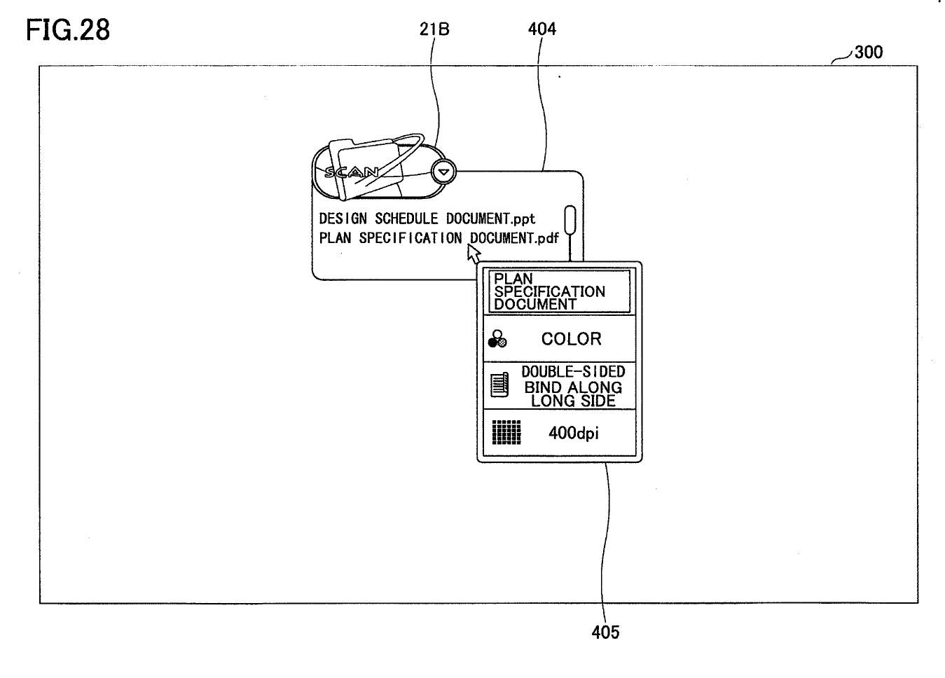

FIG. 28 illustrates a displayed setting window for scan image data.

FIG. 28 illustrates a state where a setting window 405 for a second scan image data item is displayed. The setting window 403 described with reference to FIG. 24 is for specifying setting information for the scan widget 21B. The setting information of FIG. 24 is common to jobs to be executed in the future. Meanwhile, the setting window 405 in FIG. 28 is for specifying setting information for the current image data, i.e., a single job that has been executed in the past. In the present embodiment, the setting items in both of the setting windows 403 and 405 are the same; however, the settings items of these setting windows need not be the same. In the initial state of the setting window 405, the setting values displayed in the setting items correspond to the current state (attribute information) of the current image data. That is to say, the display control unit 2111B acquires, from the current image data, attribute information of the current image data, and records, into the memory device 203, the setting values of the setting items included in the acquired attribute information. The display control unit 2111B displays The setting values recorded in the memory device 203 in the setting window 405. The attribute information of the current image data may be managed in a separate file from the current image data. In this case, when the scan image data is transferred from the image forming apparatus 10 to the scan widget 21B via the widget manager 22, the attribute information of the scan image data also is to be transferred together with the scan image data.

Next, the region decision unit 2113B determines whether the pointer 301 is inside the display region of the setting window 405 (step S703). When the pointer 301 is inside the display region of he setting window 405 (Yes in step S703), the region decision unit 2113B determines whether any of the setting item regions (specification regions allocated for setting items) have been specified, in the display region of the setting window 405 (step S704). The specification of a setting item region may be performed by simply placing the pointer 301 in the setting item region or by executing a single-click while the pointer 301 is in the setting item region. When the region decision unit 2113B determines that one of the setting item regions have been specified, and identifies the setting item that has been specified (Yes in step S704), the display control unit 2111B displays a setting value selection menu for the specified setting item (hereinafter, “current setting item”) (step S705).

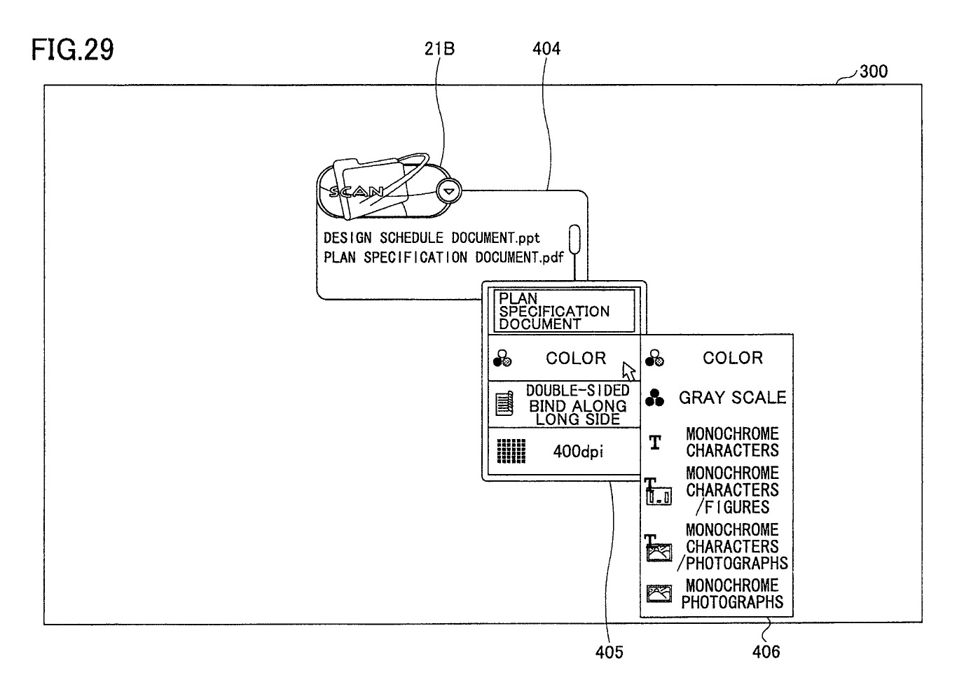

FIG. 29 illustrates a displayed setting value selection menu. FIG. 29 illustrates a displayed setting value selection menu 406 for a color setting item. The setting value selection menu 406 is displaying a list of options of setting values that can be set for the current setting item (color setting item).

In the setting value selection menu 406, when one of the setting values is selected, the setting input receiving unit 2114B updates the setting value recorded in the memory device 203 for the current setting item, to the selected setting item (step S706). Subsequently, the display control unit 2111B erases (hides) the setting value selection menu 406 (step S707). As the setting value selection menu 406 is erased, the display control unit 2111B applies the selected setting value to the setting window 405.

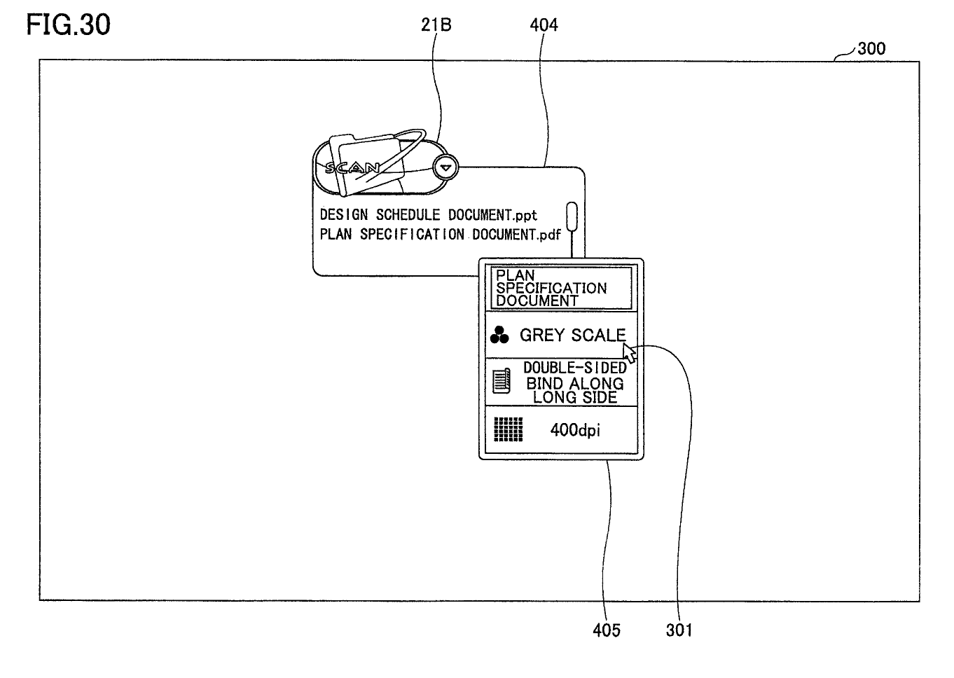

FIG. 30 illustrates a displayed setting window after the setting value has been changed. FIG. 30 illustrates a case where “grayscale” has been selected in the setting value selection menu 406 shown in FIG. 29.

In the setting window 405, the names of the setting items are not expressed by character strings, but the setting items are expressed by icons and setting values. This is to minimize the size of the setting window 405. That is to say, if the item names, were expressed by character strings, and the character strings were arranged beside the setting values (horizontally), the setting window 405 would need to be wide enough to accommodate the character strings. In another example, as in the setting window 303 of the print widget 21A shown in FIG. 10, if the character strings were arranged above the setting values (vertically), the setting window 405 would need to be long (high) enough to accommodate the character strings (in the vertical direction). That is to say, the size of the setting window 405 can be reduced by not displaying character strings. Even if character strings were not displayed, it would be easy to understand the meanings of the current setting items by referring to the options of setting values displayed in the setting value selection menu 406. For that matter, even the icons expressing the setting items may not be displayed.

As described below, the setting window 405 has very good operability, similar to the setting window 303. Considering the balance in operability, the size of the setting window 405 is preferably small.

Meanwhile, when the region decision unit 2113B detects that the pointer 301 has moved out of the display region of the setting window 405 (No in step S703), the display control unit 2111B gradually erases the setting window 303 (step S708).

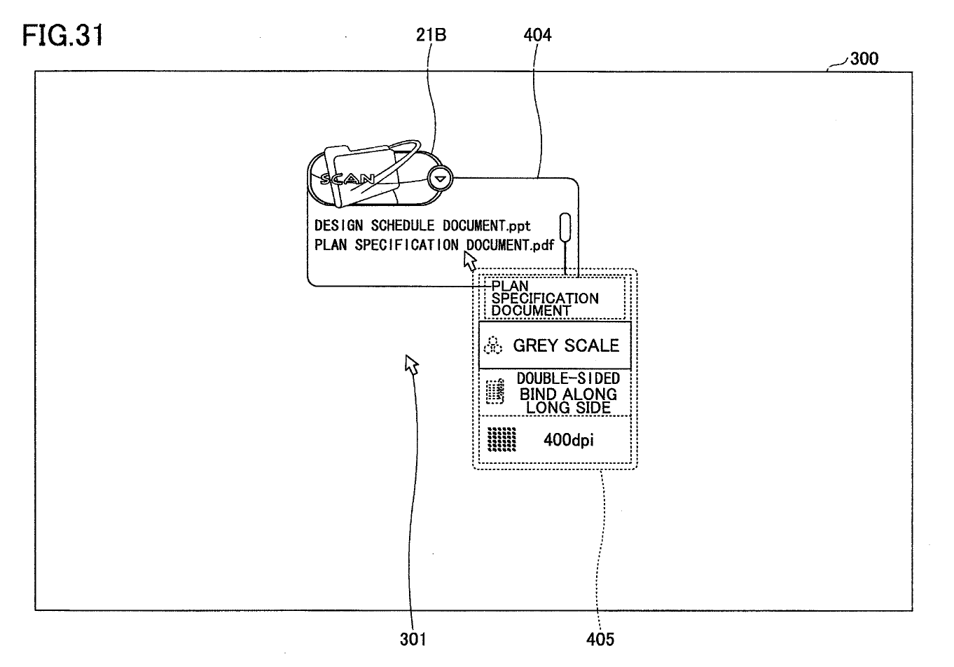

FIG. 31 illustrates an example where the setting window 405 is gradually erased. In FIG. 31, the setting window 405 is depicted with dotted lines. This is to express that the setting window 405 is gradually being erased. The meaning of gradually being erased is the same as that described for the setting window 303 with reference to FIG. 11.

When the region decision unit 2113B detects that the pointer 301 has once again moved into the display region of the setting window 405 before a predetermined time period elapses after the region decision unit 2113A detects that the pointer 301 has moved out of the display region of the setting window 405 (No in step S709 and Yes in step S710), the process returns to step S702. Thus, the setting window 405 is completely displayed once again. Accordingly, the user can make changes in the setting values. When the setting values are changed, the changes are applied to the setting values recorded in the memory device 203.

When a predetermined time period has elapsed after the region decision unit 2113B has detected that the pointer 301 has moved outside the display region of the setting window 405 (Yes in step S709), the display control unit 2111B completely erases the setting window 405 (step S711).

Next, the setting decision unit 2115B decides the setting information with the setting value recorded in the memory device 203 (step S712). In response to the decision of the setting information, the logic unit 214B of the scan widget 21B executes a process of converting the current image data into a data format corresponding to the decided setting information.

Meanwhile, when none of the scan image data items are specified in the job list window 404 (No in step S701), and the mouse button is pressed while the pointer 301 is inside the blank region (while the blank region is held) (Yes in step S721), the movement control unit 2116B determines whether the scan widget 21B has been dragged (whether the pointer 301 has moved while the mouse button is pressed) (step S722).

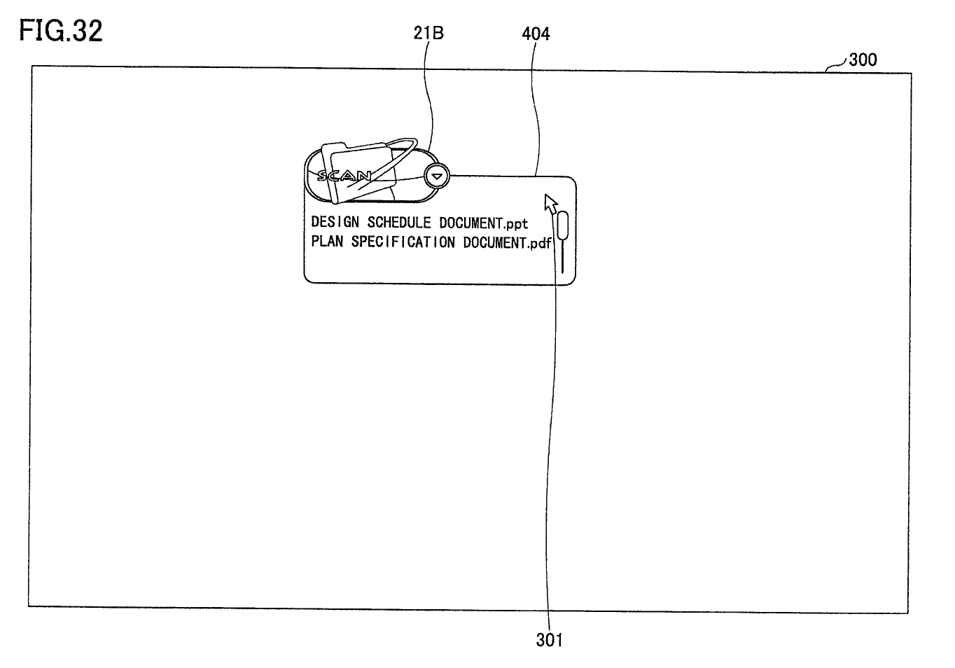

FIG. 32 illustrates a state where the blank region of the job list window 404 is held.

When the scan widget 21B is dragged while the blank region is held (Yes in step S722), the movement control unit 2116B updates the position information of the scan widget 21B on the display screen page 300 in accordance with the movement of the pointer 301 (step S723). As a result, the position where the scan widget 21B is displayed moves in accordance with the movement of the pointer 301.

As described above, the scan widget 21B can be moved by being dragged while the blank area in the job list window 404 is being held. This operation of moving the scan widget 21B can be performed because a process of displaying the setting window 403 (see FIG. 24) is allocated to the operation of single-clicking the scan widget 21B. Details are given below.

The widget 21 is expected to be used in various application platforms (widget platforms). Inventors of the present invention noticed that there is an application platform on which an event relevant to a single click and an event relevant to an operation of merely pressing the mouse button interfere with each other. Specifically, a single click is an operation of pressing the mouse button and then releasing the mouse button, which is normally distinguished from an operation of pressing the mouse button. Thus, under normal circumstances, a certain operation (for example, displaying the setting window 403) can be allocated to a single click, while a movement process (moving the icon) is allocated to the operation of pressing the mouse button. However, on an application where a single click and an operation of pressing the mouse button interfere with each other (i.e., the respective events are erroneously treated as the same event), the following problem arises. Specifically, when the mouse button is pressed while the pointer 301 is on the scan widget 21B, a single-click event occurs. As a result, the job list window 404 is displayed when the mouse button is pressed, such that the scan widget 21B cannot be dragged immediately after pressing the mouse button.

Thus, the present embodiment is configured in consideration of such an application platform on which a single-click and an operation of pressing a mouse button interfere with each other. Accordingly, the scan widget 21B can be moved by holding a blank region of the job list window 404.

As for the print widget 21A, the operation of displaying a window is not allocated to a single click. Therefore, even on an application where a single click and an operation of pressing the mouse button interfere with each other, the print widget 21A can be moved by a dragging operation, as described in the first embodiment.

Compared to the operation of moving the print widget 21A, the operation of moving the scan widget 21B is complex. Thus, in the present embodiment, the scan widget 21B is moved by performing a simple operation as described below.

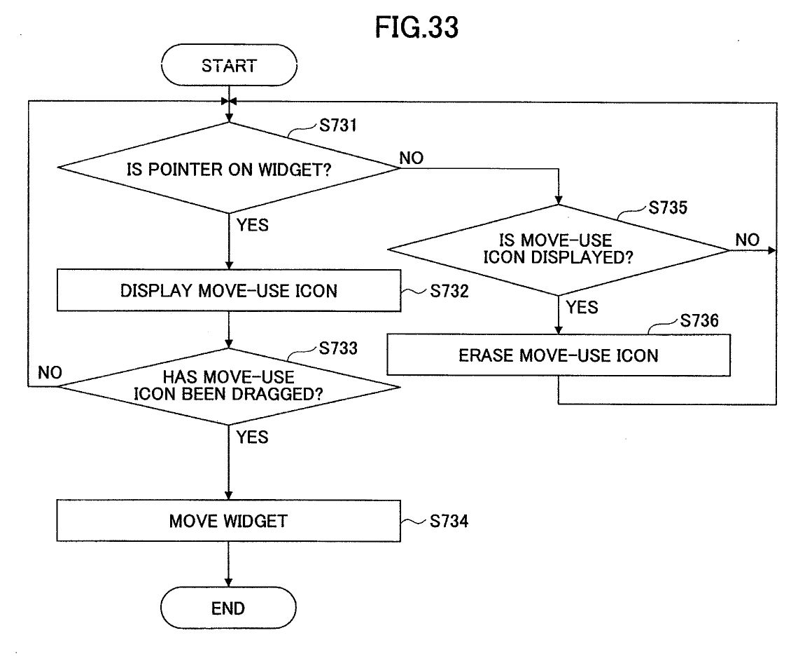

FIG. 33 is a flowchart for describing the process of moving the scan widget 21B by a simple operation.

When the region decision unit 2113B detects that the pointer 301 has moved into the display region of the scan widget 21B (Yes in step S731), the display control unit 2111B displays, near the scan widget 21B, an image for receiving an instruction to move the scan widget 21B (hereinafter, “move-use icon”) (step S732).

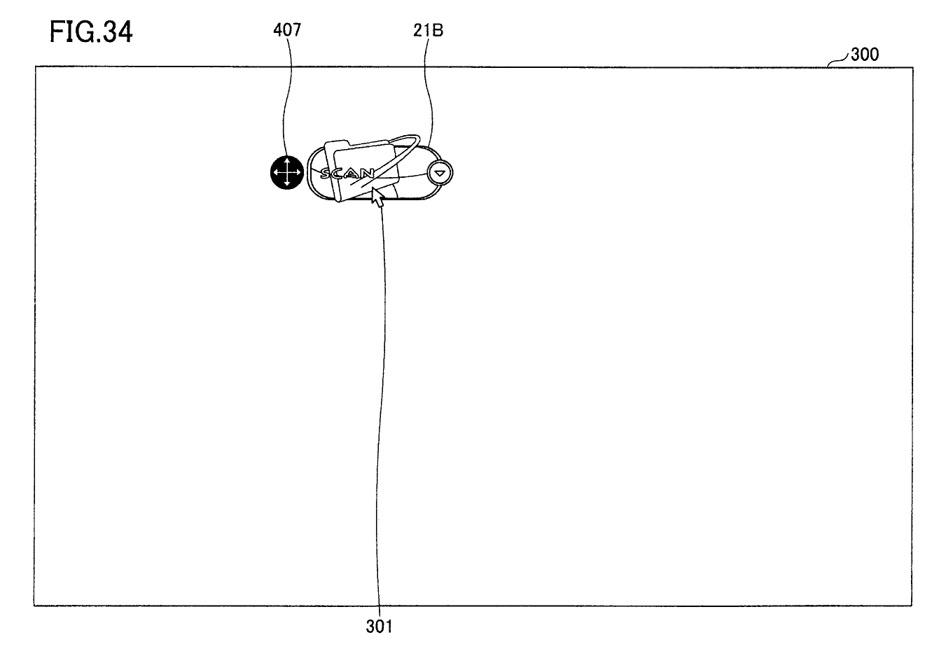

FIG. 34 illustrates a displayed move-use icon for the scan widget 21B. As shown in FIG. 34, a move-use icon 407 is displayed on the left side of the scan widget 21B. However, the display position of the move-use icon 407 is not limited to a particular position as long as it is near the scan widget 21B (within a predetermined number of pixels from the scan widget 21B). Technically, the move-use icon 407 may be displayed away from the scan widget 21B. However, in consideration of operability, the move-use icon 407 is preferably displayed near the scan widget 21B.

Next, when the region decision unit 2113B detects that the pointer 301 has moved into the display region of the move-use icon 407, and detects that the mouse button is pressed and the scan widget 21B is dragged (Yes in step S733), the movement control unit 2116B updates the position information of the scan widget 21B on the display screen page 300 in accordance with the movement of the pointer 301 (step S734). As a result, the display position of the scan widget 21B moves in accordance with the movement of the pointer 301.

When the pointer 301 moves outside the display region of the scan widget 21B (No in step S731), if the move-use icon 407 is displayed (Yes in step S735), the display control unit 2111B erases (hides) the move-use icon 407 (step S736).

By using the move-use icon 407, the operation of moving the scan widget 21B can be simplified. In particular, the move-use icon 407 is displayed when the pointer 301 moves into the display region of the scan widget 21B, i.e., the move-use icon 407 is displayed without pressing the mouse button. Therefore, substantially the same operability as that of moving the print widget 21A can be achieved.

In the present embodiment, descriptions are given of operations of the icon and the setting window of the widget 21; however, the present embodiment may be applied to various GUIs (Graphical User Interfaces) of various programs other than the widget 21.

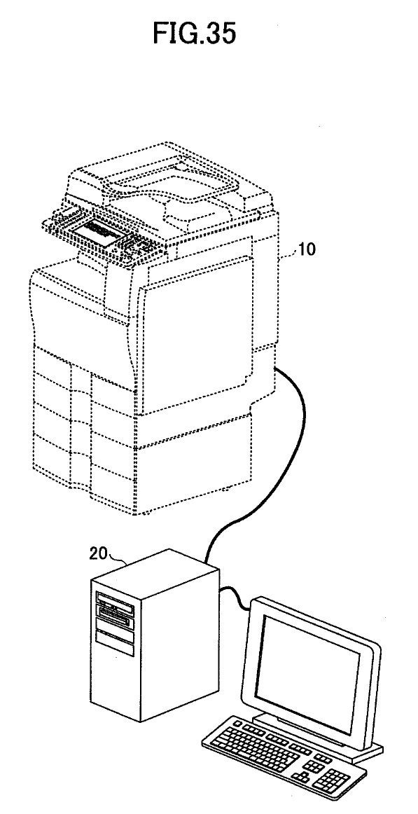

FIG. 35 is a perspective view of the image forming apparatus 10, the user terminal 20, and the display device of the user terminal 20 according to an embodiment of the present invention.

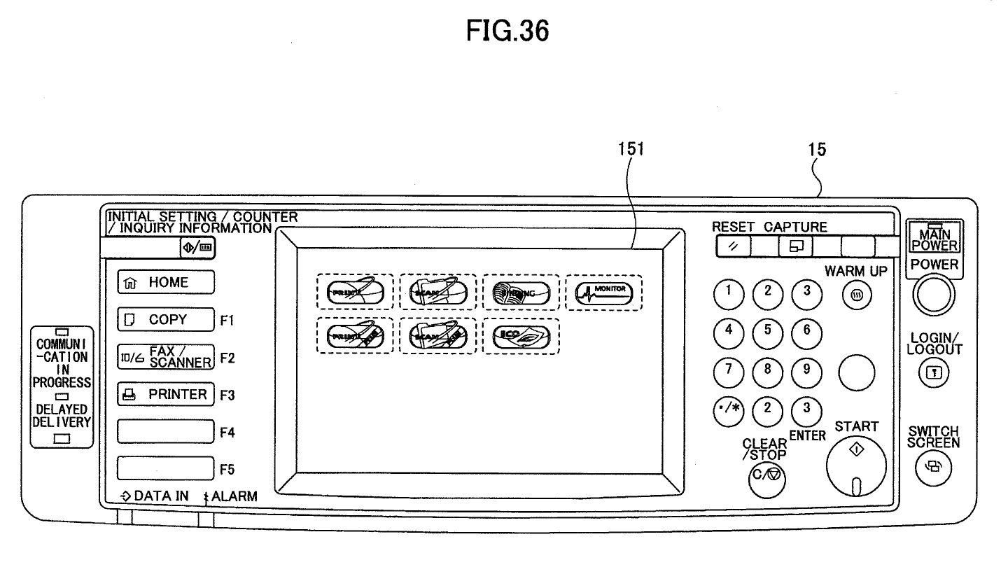

FIG. 36 is a reference diagram illustrating an example of an operation screen page of the operations panel 15 of the image forming apparatus 10 according to an embodiment of the present invention. In FIG. 36, a liquid display unit 151 of the operations panel 15 is displaying a widget selection screen page.

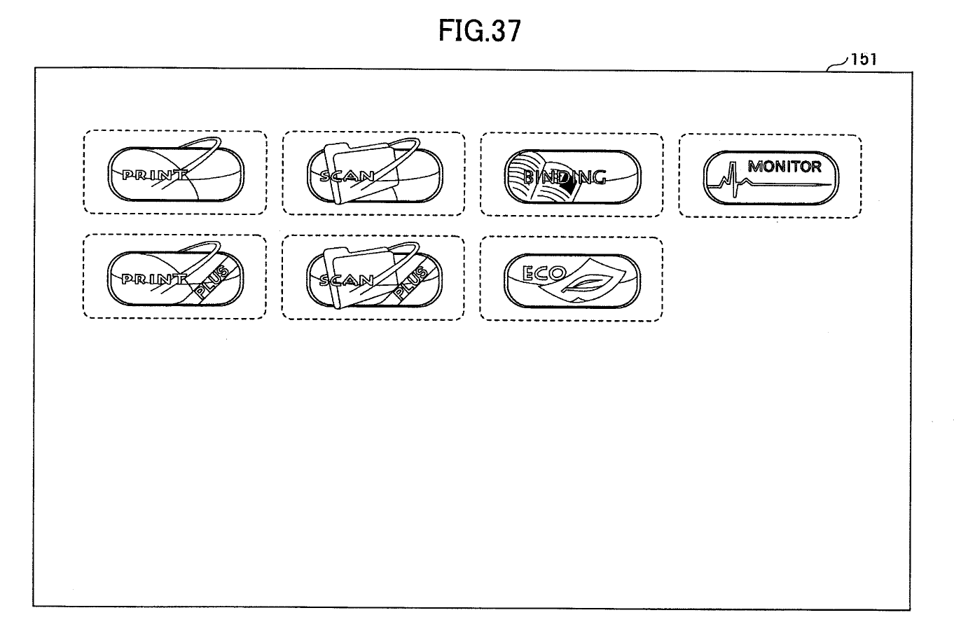

FIG. 37 is an enlarged view of the liquid display unit 151 of the operations panel 15. In FIG. 18, the widgets 21 are depicted in a simplified manner as a matter of convenience; however, in FIGS. 36 and 37, each of the widgets 21 is depicted in detail.

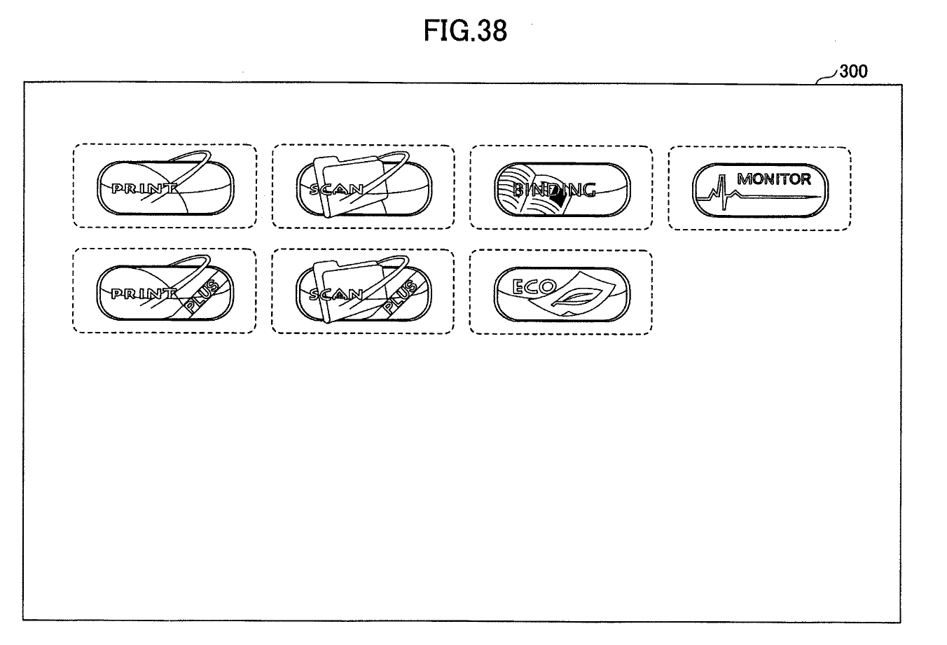

FIG. 38 is an enlarged view of a display screen page of a display device connected to the user terminal 20 according to an embodiment of the present invention. FIG. 38 illustrates a state where the widgets are displayed on the display screen page 300.

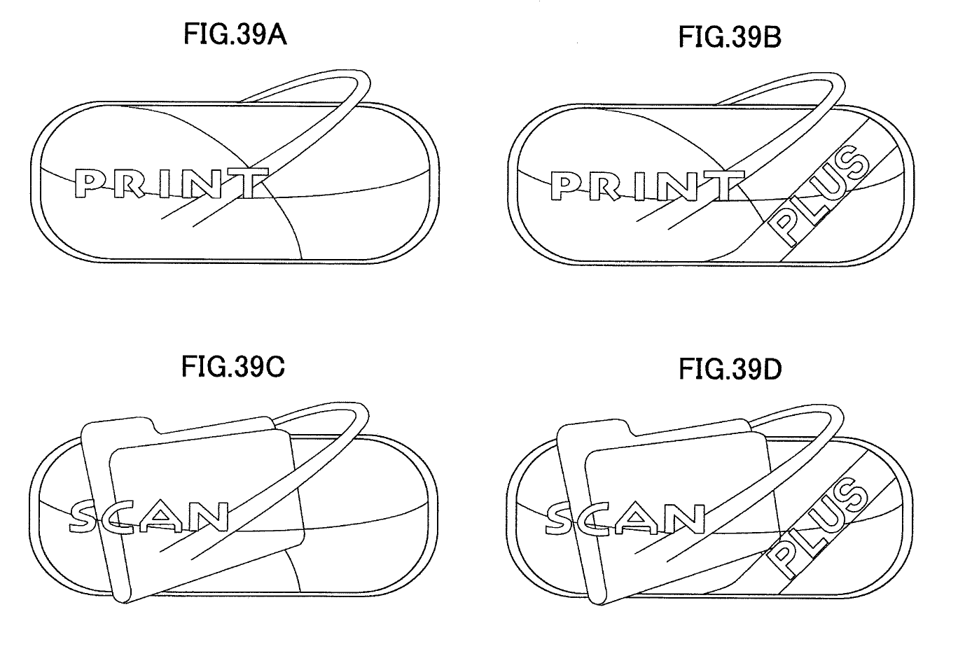

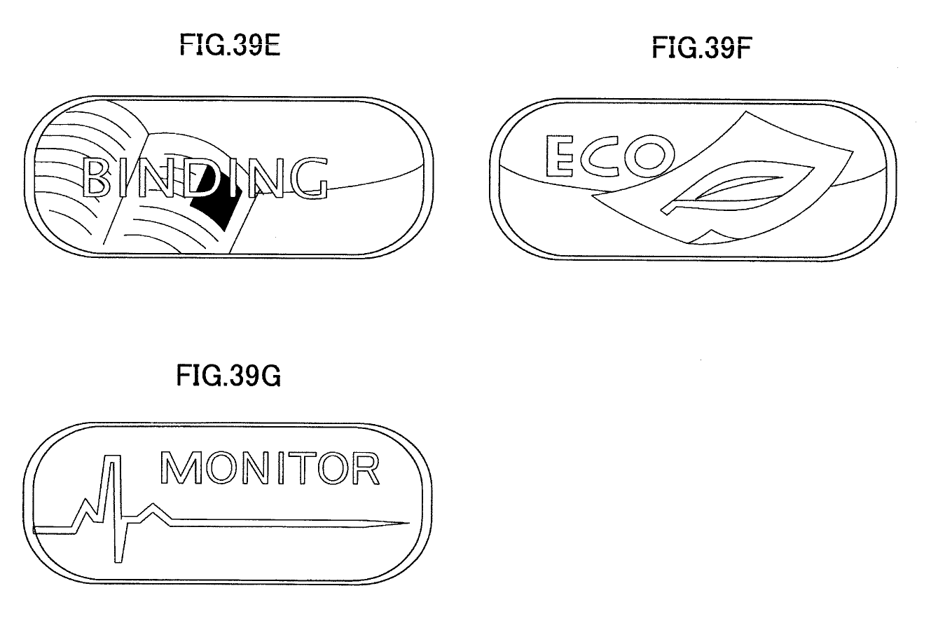

FIGS. 39A through 39G are enlarged views of each of the widgets illustrated in FIGS. 37 and 38.

According to an aspect of the present invention, there is provided a display control method of causing a computer to execute a display control step of causing a display device to display a setting screen page to which a setting information item of a predetermined process is input; and a hide control step of hiding the setting screen page in response to an indication position of a pointing device moving out of a display region of the setting screen page.

According to an aspect of the present invention, there is provided a display control method of causing a computer to execute a display control step of causing a display device to display a second image used for moving a first image expressing a predetermined program, the display device being caused to display the second image in response to an indication position of a pointing device moving into a display region of the first image; and a movement control step of moving a display position of the first image in response to the pointing device executing an operation on the second image.

The present invention is not limited to the specific embodiments described herein, and variations and modifications may be made without departing from the scope of the present invention.

The present application is based on Japanese Priority Patent Application No. 2009-138075, filed on Jun. 9, 2009 and Japanese Priority Patent Application No. 2010-002328, filed on Jan. 7, 2010, the entire contents of which are hereby incorporated herein by reference.

What is claimed is:

1. A display control apparatus comprising:
a display control unit configured to cause a display device to display a setting screen page to which a setting information item of a predetermined process is input, and to hide the setting screen page in response to an indication position of a pointing device moving out of a display region of the setting screen page.

2. The display control apparatus according to claim 1, wherein
the display control unit gradually hides the setting screen page over a predetermined time period in response to the indication position moving out of the display region of the setting screen page, and displays the setting screen page once again in response to the indication position moving into the display region within the predetermined time period.

3. A display control apparatus comprising:
a display control unit configured to cause a display device to display a second image used for moving a first image expressing a predetermined program, the display device being caused to display the second image in response to an indication position of a pointing device moving into a display region of the first image; and
a movement control unit configured to move a display position of the first image in response to the pointing device executing an operation on the second image.

4. The display control apparatus according to claim 3, wherein
the display control unit causes the display device to display a predetermined screen page in response to the pointing device executing a single click on the first image.

5. The display control apparatus according to claim 4, wherein
the movement control unit moves the display position of the first image in response to the pointing device executing an operation on a part of the predetermined screen page.

6. An information processing system comprising:
an image forming apparatus and
a program product, wherein the program product causes a computer connected to the image forming apparatus to execute
a display control step of causing a display device to display a setting screen page to which a setting information item of a predetermined process is input, and to hide the setting screen page in response to an indication position of a pointing device moving out of a display region of the setting screen page; and
a process request step of sending, to the image forming apparatus, a request to perform a process relevant to the predetermined process, in accordance with the setting information item.
